(19) United States
(12) Patent Application Publication
(10) Pub. No.: US 2022/0060999 A1
(43) Pub. Date: Feb. 24, 2022

(54) METHOD AND APPARATUS FOR DETERMINATION OF TRANSMISSION POWER IN WIRELESS COMMUNICATION SYSTEM

(71) Applicant: Samsung Electronics Co., Ltd., Suwon-si (KR)

(72) Inventors: Jinyoung OH, Suwon-si (KR); Taehyoung KIM, Suwon-si (KR); Jinhyun PARK, Suwon-si (KR); Youngrok JANG, Suwon-si (KR); Hyoungju JI, Suwon-si (KR)

(21) Appl. No.: 17/406,554

(22) Filed: Aug. 19, 2021

(30) Foreign Application Priority Data
Aug. 20, 2020 (KR) 10-2020-0104820

(51) Int. Cl. H04W 52/36; H04W 52/14

(52) U.S. Cl. CPC H04W 52/367; H04W 92/18; H04W 52/146

(57) ABSTRACT

The disclosure relates to a communication technique for convergence between an IoT technology and a 5^{th} generation (5G) communication system for supporting a higher data transmission rate than a 4^{th} generation (4G) system, and a system thereof. The disclosure may be applied to intelligence services (for example, smart homes, smart buildings, smart cities, smart cars or connected cars, healthcare, digital education, retail businesses, security and safety related services, etc.) on the basis of a 5G communication technology and an IoT-related technology. The disclosure provides a method and an apparatus for determining transmission power for transmission of an uplink signal and/or channel or a sidelink signal and/or channel, which is applied in an unlicensed band.

### CROSS-REFERENCE TO RELATED APPLICATION(S)

This application is based on and claims priority under 35 U.S.C. § 119(a) of a Korean patent application number 10-2020-0104820, filed on Aug. 20, 2020, in the Korean Intellectual Property Office, the disclosure of which is incorporated by reference herein in its entirety.

### BACKGROUND

### 1. Field

The disclosure relates to a method and an apparatus for determination of uplink transmission power in a wireless communication system.

### 2. Description of Related Art

To meet the demand for wireless data traffic having increased since deployment of 4th-generation (4G) communication systems, efforts have been made to develop an improved 5th-generation (5G) or pre-5G communication system. Therefore, the 5G or pre-5G communication system is also called a “beyond 4G network” or a “post long term evolution (LTE)/LTE-advanced (LTE-A) system (post LTE/LTE-A system)”.

The 5G communication system is considered to be implemented in higher frequency (mmWave) bands, e.g., 60 gigahertz (GHz) bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, hybrid frequency shift keying (FSK) and quadrature amplitude modulation (QAM) (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have also been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (RAN) as the above-described big data processing technology may also be considered an example of convergence of the 5G technology with the IoT technology.

With the advance of mobile communication systems as described above, various services can be provided and wireless communication networks are becoming complex and diverse, and accordingly there is a need for ways to efficiently allocate downlink and uplink data channels.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for determination of transmission power for transmitting an uplink signal and/or channel or a sidelink signal and/or channel by a terminal in an unlicensed band.

Additional aspects will be set forth in part in the description which follows and, in part, will be apparent from the description, or may be learned by practice of the presented embodiments.

In accordance with an aspect of the disclosure, a method performed by a terminal in a communication system is provided. The method includes receiving, from a base station, information on at least one of maximum transmit power or power spectral density (PSD) for an unlicensed band via higher layer signaling; identifying a transmit power of an uplink signal or a sidelink signal based on the information on at least one of the maximum transmit power or the PSD; and transmitting the uplink signal or the sidelink signal based on the identified transmit power on the unlicensed band, wherein the unlicensed band corresponds to a 6 gigahertz (GHz) band.

In accordance with another aspect of the disclosure, a method performed by a base station in a communication system is provided. The method includes transmitting, to a terminal, information on at least one of maximum transmit power or power spectral density (PSD) for an unlicensed band via higher layer signaling; and receiving, from the terminal, an uplink signal associated with a transmit power on the unlicensed band, wherein the transmit power of the uplink signal corresponds to the information on at least one of the maximum transmit power or the PSD, and wherein the unlicensed band corresponds to a 6 gigahertz (GHz) band.

In accordance with another aspect of the disclosure, a terminal in a communication system is provided. The terminal includes a transceiver and a controller coupled with the transceiver and configured to receive, from a base station, information on at least one of maximum transmit power or power spectral density (PSD) for an unlicensed band via higher layer signaling, identify a transmit power of an uplink signal or a sidelink signal based on the information on at least one of the maximum transmit power or the PSD, and transmit the uplink signal or the sidelink signal based on the identified transmit power on the unlicensed band, wherein the unlicensed band corresponds to a 6 gigahertz (GHz) band.

In accordance with another aspect of the disclosure, a base station in a communication system is provided. The base station includes a transceiver and a controller coupled with the transceiver and configured to transmit, to a terminal, information on at least one of maximum transmit power or power spectral density (PSD) for an unlicensed band via higher layer signaling, and receive, from the terminal, an uplink signal associated with a transmit power on the unlicensed band, wherein the transmit power of the uplink signal corresponds to the information on at least one of the maximum transmit power or the PSD, and wherein the unlicensed band corresponds to a 6 gigahertz (GHz) band.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2 illustrates a configuration of a base station in a wireless communication system according to an embodiment of the disclosure;

FIG. 3 illustrates a configuration of a terminal in a wireless communication system according to an embodiment of the disclosure;

FIG. 4 illustrates a configuration of a communication unit in a wireless communication system according to an embodiment of the disclosure;

FIG. 5 illustrates structures of a frame, a subframe, and a slot in a 5G communication system according to an embodiment of the disclosure;

FIG. 6 illustrates a basic structure of a time-frequency area in a 5G communication system according to an embodiment of the disclosure;

FIG. 7 illustrates an example of a configuration of a bandwidth part and an intra-cell guard-band in a 5G communication system according to an embodiment of the disclosure;

FIG. 8 illustrates an example of a configuration of a control resource set of a downlink control channel in a 5G communication system according to an embodiment of the disclosure;

FIG. 9 illustrates a structure of a downlink control channel in a 5G communication system according to an embodiment of the disclosure;

FIG. 10 illustrates an example of an uplink-downlink configuration in a 5G communication system according to an embodiment of the disclosure;

FIG. 11 illustrates an example of a channel access procedure for semi-static channel occupancy in a wireless communication system according to an embodiment of the disclosure;

FIG. 12 illustrates an example of a channel access procedure for dynamic channel occupancy in a wireless communication system according to an embodiment of the disclosure; and

FIG. 13 illustrates an operation of a terminal which performs an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Further, in the following description of the disclosure, a detailed description of known functions or configurations incorporated herein will be omitted when it may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, a base station (BS) is an entity that assigns resources of a terminal, and may be at least one of a gNode B, an eNode B, a Node B (or an xNode B (here, x includes letters including g and e), a wireless access unit, a base station controller, a satellite, an airborne flight object, or a node on a network. A terminal (a user equipment (UE)) may include a mobile station (MS), a vehicle, a satellite, an airborne flight object, a cellular phone, a smartphone, a computer, or a multimedia system capable of performing a communication function. In the disclosure, a downlink (DL) means a radio transmission path of a signal transmitted from a base station to a terminal, and an uplink (UL) means a radio transmission path of a signal transmitted from a terminal to a base station. In addition, there may be a sidelink (SL) meaning a radio transmission path of a signal transmitted from a terminal to another terminal.

In addition, hereinafter, the LTE, LTE-A, or 5G system is described as an example, but embodiments of the disclosure may be applied to other communication systems having a similar technical background or channel type. For example, a 5G-advance, an NR-advance, or a 6^{th} generation (6G) mobile communication technology developed beyond a 5G mobile communication technology (or new-radio (NR)) can be included therein, and hereinafter, 5G may be a concept including the existing LTE, LTE-A, and other similar services. Furthermore, the disclosure may be applied to other communication systems through some modifications without greatly departing from the range of the disclosure according to a determination of those having skilled technical knowledge.

Here, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Further, the “unit” in the embodiments may include one or more processors.

Wireless communication systems have expanded beyond the original role of providing a voice-oriented service and have evolved into wideband wireless communication systems that provide a high-speed and high-quality packet data service according to, for example, communication standards such as high-speed packet access (HSPA), long-term evolution (LTE or evolved universal terrestrial radio access (E-UTRA)), and LTE-Advanced (LTE-A) of 3GPP, high-rate packet data (HRPD) and a ultra-mobile broadband (UMB) of 3GPP2, and 802.16e of IEEE.

As a representative example of the broadband wireless communication systems, in an LTE system, an orthogonal frequency-division multiplexing (OFDM) scheme has been adopted for a downlink (DL), and both the OFDM scheme and a single carrier frequency division multiple access (SC-FDMA) scheme have been adopted for an uplink (UL). The uplink indicates a radio link through which data or a control signal is transmitted from a terminal to a base station, and the downlink indicates a radio link through which data or a control signal is transmitted from a base station to a terminal. In the above-mentioned multiple-access scheme, normally, data or control information is distinguished according to a user by assigning or managing time-frequency resources for carrying data or control information of each user, wherein the time-frequency resources do not overlap, that is, orthogonality is established.

A future communication system subsequent to the LTE, that is, a 5G communication system, has to be able to freely reflect various requirements from a user, a service provider, and the like, and thus a service satisfying all of the various requirements needs to be supported. The services considered for the 5G communication system include enhanced mobile broadband (eMBB), massive machine-type communication (mMTC), ultra-reliable low-latency communication (URLLC), etc.

The eMBB aims to provide a data rate superior to the data rate supported by the existing LTE, LTE-A, or LTE-Pro. For example, in the 5G communication system, the eMBB should be able to provide a peak data rate of 20 Gbps in the downlink and a peak data rate of 10 Gbps in the uplink from the viewpoint of one base station. In addition, the 5G communication system should be able to provide not only the peak data rate but also an increased user-perceived terminal data rate. In order to satisfy such requirements, improvement of various transmitting and receiving technologies including a further improved multi-input multi-output (MIMO) transmission technology is required in the 5G communication system. In addition, a signal is transmitted using a transmission bandwidth of up to 20 megahertz (MHz) in the 2 GHz band used by the current LTE, but the 5G communication system uses a bandwidth wider than 20 MHz in the frequency band of 3 to 6 GHz or 6 GHz or higher, thereby satisfying the data rate required in the 5G communication system.

The mMTC is being considered to support application services such as the Internet of Things (IoT) in the 5G communication system. The mMTC may be required to support access by a large number of terminals in a cell, coverage enhancement of a terminal, improved battery time, and cost reduction of a terminal in order to efficiently provide the IoT. The IoT needs to be able to support a large number of terminals (for example, 1,000,000 terminals/km²) in a cell because it is attached to various sensors and devices to provide communication functions. A terminal supporting mMTC is more likely to be located in a shaded area that is not covered by a cell due to the nature of services, such as a basement of a building, and thus the terminal requires wider coverage than other services provided in the 5G communication system. The terminal supporting mMTC needs to be configured as an inexpensive terminal and may require a very long battery life time, such as 10 to 15 years, because it is difficult to frequently replace the battery of the terminal.

The URLLC is a cellular-based wireless communication service used for mission-critical purposes. For example, services used for remote control for a robot or machinery, industrial automation, an unmanned aerial vehicle, remote health care, an emergency alert, or the like, may be considered. Therefore, the communication provided by the URLLC may provide ultra-low latency and ultra-high reliability. For example, a service that supports the URLLC needs to satisfy air interface latency of less than 0.5 milliseconds, and may also have requirements of a packet error rate of 10-5 or lower. Therefore, for the service that supports the URLLC, the 5G system needs to provide a transmission time interval (TTI) smaller than those of other services, and design matters for allocating wide resources in the frequency band in order to secure reliability of the communication link may also arise.

The above-described three services considered in the 5G communication system, that is, the eMBB, the URLLC, and the mMTC, may be multiplexed and transmitted in a single system. In this case, in order to satisfy the different requirements of each of the services, different transmission or reception schemes and different transmission and reception parameters may be used for the services. Services in the 5G communication system are not limited to the above-described three services.

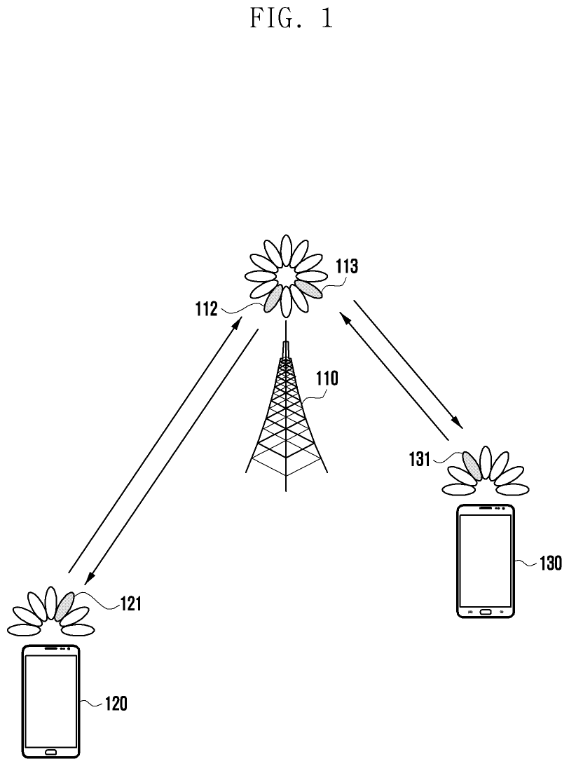

FIG. 1 illustrates a wireless communication system according to an embodiment of the disclosure. FIG. 1 illustrates a base station 110, a terminal 120, and a terminal 130 as nodes using a radio channel in a wireless communication system. FIG. 1 illustrates only one base station, but may further include another base station that is identical or similar to the base station 110.

Referring to FIG. 1, the base station 110 may be a network infrastructure that provides wireless access to the terminals 120 and 130. The base station 110 has coverage defined for a predetermined geographical area based on a reaching distance at which a radio signal can be transmitted. The base station 110 may also be referred to as an “access point (AP)”, an “eNodeB (eNB)”, a “gNodeB (gNB)”, a 5^{th} generation (5G) node”, a “wireless point”, a “transmission/reception point (TRP)”, or other terms having equivalent technical meanings to those of the above-described terms.

Each of the terminals 120 and 130 may be a device which can be used by a user, and may perform communication with the base station 110 through a wireless channel. At least one of the terminals 120 and 130 may operate without user involvement. That is, at least one of the terminals 120 and 130 may be a device that performs machine type communication (MTC), and is not be necessarily carried by the user. Each of the terminals 120 and 130 may also be referred to as a “mobile station”, a “subscriber station”, a “remote terminal”, a “wireless terminal”, a “user device”, a “station (STA)”, or other terms having equivalent technical meanings to those of the above-described terms.

The wireless communication environment may include wireless communication in not only a licensed band but also an unlicensed band. The base station 110, the terminal 120, and the terminal 130 may transmit and receive a radio signal in an unlicensed band (e.g., 5 to 7.125 GHz and 71 GHz or lower). In an embodiment, in the unlicensed band, a cellular communication system and another communication system (for example, a wireless local area network (WLAN)) may coexist. The base station 110, the terminal 120, and the terminal 130 may perform a channel access procedure for the unlicensed band in order to guarantee fairness between two communication systems, that is, in order to prevent a channel being exclusively used by only one system. As an example of the channel access procedure in the unlicensed band, the base station 110, the terminal 120, and the terminal 130 may perform listen-before-talk (LBT).

The base station 110, the terminal 120, and the terminal 130 may transmit and receive a radio signal in a millimeter wave (mmWave) band (e.g., 28 GHz, 30 GHz, 38 GHz, or 60 GHz). In this case, to increase a channel gain, the base station 110, the terminal 120, and the terminal 130 may perform beamforming. Here, beamforming may include transmission beamforming and/or reception beamforming. That is, the base station 110, the terminal 120, and the terminal 130 may assign directivity to a transmission signal and a reception signal. To this end, the base station 110 and the terminals 120 and 130 may select serving beams through a beam search procedure or beam management procedure. After the serving beams are selected, communication may be performed through resources having a quasi-co-located relationship with resources through which the serving beams are transmitted.

The base station 110 may select a beam 112 or 113 in a particular direction. The base station 110 may perform communication with a terminal by using the beam 112 or 113 in the particular direction. For example, the base station 110 may receive a signal from the terminal 120 or transmit a signal to the terminal 120 by using the beam 112. The terminal 120 may receive a signal from the base station 110 or transmit a signal to the base station 110 by using the beam 121. In addition, the base station 110 may receive a signal from the terminal 130 or transmit a signal to the terminal 130 by using the beam 113. The terminal 130 may receive a signal from the base station 110 or transmit a signal to the base station by using the beam 131.

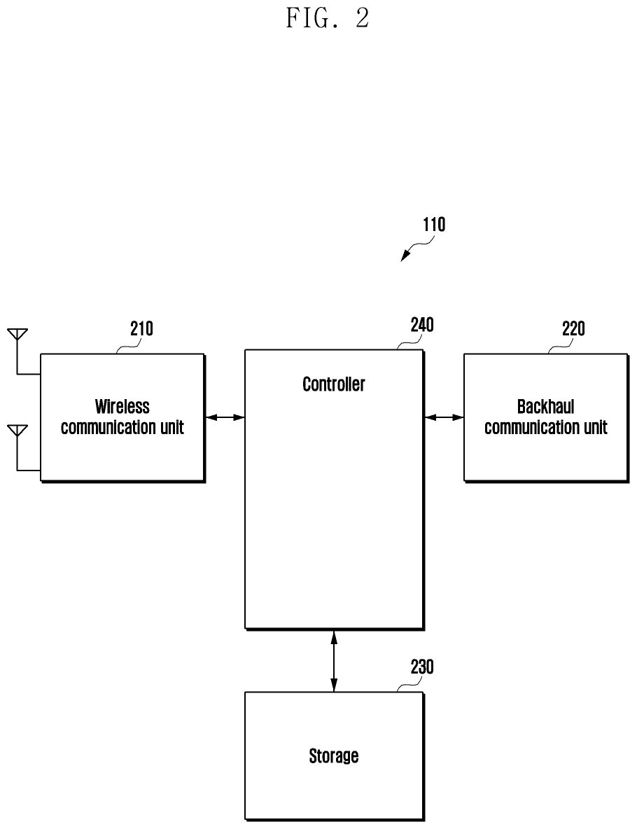

FIG. 2 illustrates a configuration of a base station in a wireless communication system according to an embodiment of the disclosure.

The configuration illustrated in FIG. 2 may be understood as a configuration of the base station 110 of FIG. 1. The term “unit”, “-or/er”, or the like, to be used below may indicate a unit for processing at least one function or operation, and may be implemented by hardware, software, or a combination thereof.

Referring to FIG. 2, the base station may include a wireless communication unit 210, a backhaul communication unit 220, a storage 230, and a controller 240.

The wireless communication unit 210 (interchangeably used with a “transceiver”) may perform functions for transmitting or receiving signals through a wireless channel. For example, the wireless communication unit 210 may perform a function of conversion between a baseband signal and a bitstream according to a physical layer standard of the system. For example, for data transmission, the wireless communication unit 210 may generate complex symbols by encoding and modulating a transmission bitstream. In addition, for data reception, the wireless communication unit 210 may restore a transmission bitstream by demodulating and decoding a received baseband signal.

In addition, the wireless communication unit 210 may up-convert a baseband signal into a radio-frequency (RF) band signal and transmit the RF band signal through an antenna, and may down-convert an RF band signal received through an antenna into a baseband signal. To this end, the wireless communication unit 210 may include a transmission filter, a reception filter, an amplifier, a mixer, an oscillator, a digital-to-analog convertor (DAC), an analog-to-digital convertor (ADC), etc. In addition, the wireless communication unit 210 may include multiple chains corresponding to multiple transmission/reception paths. Furthermore, the wireless communication unit 210 may include at least one antenna array including multiple antenna elements.

In terms of hardware, the wireless communication unit 210 may include a digital unit and an analog unit, and the analog unit may include multiple sub-units according to operation power, operation frequency, etc. The digital unit may be implemented by at least one processor (e.g., a digital signal processor (DSP)).

The wireless communication unit 210 may transmit and receive the signal as described above. Accordingly, all or a part of the wireless communication unit 210 may be referred to as a “transmitter”, a “receiver”, or a “transceiver”. In addition, the transmission and reception performed through a radio channel described below may be understood as the above-described processing being performed by the wireless communication unit 210. According to an embodiment, the wireless communication unit 210 may include at least one transceiver.

The backhaul communication unit 220 may provide an interface for performing communication with other nodes within the network. That is, the backhaul communication unit 220 may convert a bitstream transmitted from the base station to another node, for example, another access node, another base station, a higher node, or a core network, into a physical signal, and convert a physical signal received from another node into a bitstream.

The storage 230 may store data such as a basic program for operating the base station, an application, configuration information, etc. The storage 230 may be configured as volatile memory, nonvolatile memory, or a combination of volatile memory and nonvolatile memory. Further, the storage 230 may provide stored data upon a request from the controller 240. In an embodiment, the storage 230 may include at least one memory.

The controller 240 may control the overall operation of the base station. For example, the controller 240 may transmit and receive a signal through the wireless communication unit 210 or the backhaul communication unit 220. In addition, the controller 240 may record data in the storage 230 and read the recorded data therefrom. The controller 240 may perform functions of a protocol stack required by the communication standard. In an embodiment, the protocol stack may be included in the wireless communication unit 210. In an embodiment, the controller 240 may include at least one processor.

The controller 240 may control the base station to perform operations according to various embodiments described below. For example, the controller 240 may perform a channel access procedure for an unlicensed band. For example, the transceiver (for example, the wireless communication unit 210) may receive signals transmitted in an unlicensed band, and the controller 240 may compare the strength of the received signal with a threshold determined according to a function value that is predefined or has a bandwidth as a factor, in order to determine whether the unlicensed band is in an idle state. In addition, for example, the controller 240 may transmit a control signal to the terminal or receive a control signal from the terminal through the transceiver. In addition, the controller 240 may transmit data to the terminal or receive data from the terminal through the transceiver. The controller 240 may determine the result of transmission of a signal transmitted to the terminal according to the control signal or data signal received from the terminal. The controller 240 may configure one piece of downlink control information (DCI) for allocating one or more data channels to one or more cells and transmit the DCI to the terminal through the wireless communication unit 210. In addition, before transmission of the DCI, the controller 240 may provide the terminal with configuration information required to allocate one or more data channels by the one piece of DCI, through higher-layer signaling. In addition, the controller 240 may transmit a data channel to the terminal or receive a data channel from the terminal according to information fields included in the DCI and the configuration information.

In addition, the controller 240 may maintain or change the length of a contention window (CW) (hereinafter, referred to as “contention window adjustment”) for the channel access procedure according to a transmission result, i.e., according to a result of reception of the control signal or the data signal by the terminal. The controller 240 may determine reference duration in order to acquire the transmission result for contention window adjustment. The controller 240 may determine a data channel for contention window adjustment in the reference duration. The controller 240 may determine a reference control channel for contention window adjustment in the reference duration. If it is determined that the unlicensed band is in the idle state, the controller 240 may occupy the channel.

In addition, the controller 240 may control the wireless communication unit 210 to receive uplink control information (UCI) from the terminal and identify whether retransmission is required and/or whether a change in a modulation and coding scheme is required for a downlink data channel by using one or more pieces of hybrid automatic repeat request acknowledgement information (HARQ-ACK) and/or channel state information (CSI) included in the uplink control information. In addition, the controller 240 may perform a control to generate downlink control information scheduling initial transmission or retransmission of downlink data or requesting transmission of uplink control information and to transmit the downlink control information to the terminal through the wireless communication unit 210. In addition, the controller 240 may control the wireless communication unit 210 to receive (re)transmitted uplink data and/or uplink control information according to the downlink control information.

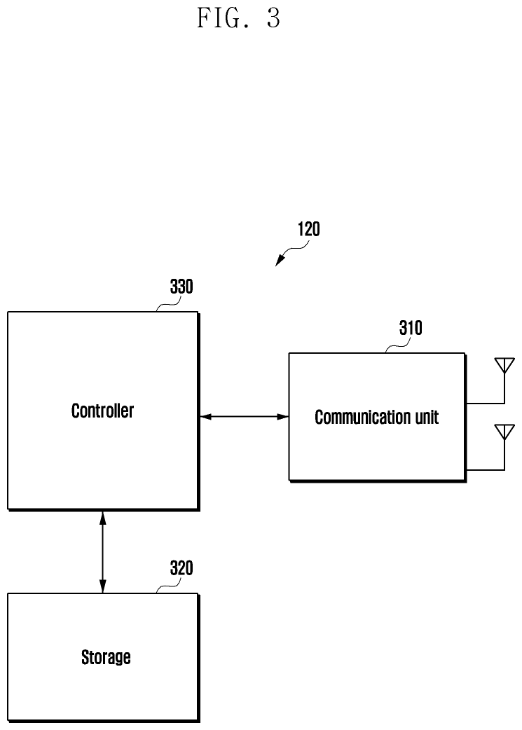

FIG. 3 illustrates a configuration of a terminal in a wireless communication system according to an embodiment of the disclosure.

The configuration illustrated in FIG. 3 may be understood as a configuration of the terminal 120 or 130 of FIG. 1. The term “unit”, “-or/er”, or the like, to be used below may indicate a unit for processing at least one function or operation, and may be implemented by hardware, software, or a combination thereof.

Referring to FIG. 3, the terminal may include a communication unit 310, a storage 320, and a controller 330.

The communication unit 310 (interchangeably used with a “transceiver”) may perform functions for transmitting or receiving a signal through a wireless channel. For example, the communication unit 310 may perform a function of conversion between a baseband signal and a bitstream according to a physical layer standard of the system. For example, for data transmission, the communication unit 310 may generate complex symbols by encoding and modulating a transmission bitstream. In addition, for data reception, the communication unit 310 may restore a transmission bitstream by demodulating and decoding a received baseband signal. In addition, the communication unit 310 may up-convert a baseband signal into an RF band signal and transmit the RF band signal through an antenna, and may down-convert an RF band signal received through an antenna into a baseband signal. For example, the communication unit 310 may include a transmission filter, a reception filter, an amplifier, a mixer, an oscillator, a DAC, an ADC, etc.

In addition, the communication unit 310 may include multiple transmission/reception paths. Furthermore, the communication unit 310 may include at least one antenna array including multiple antenna elements. In terms of hardware, the communication unit 310 may include a digital circuit and an analog circuit (e.g., an RF integrated circuit (RFIC)). Here, the digital circuit and the analog circuit may be implemented as a single package. In addition, the communication unit 310 may include multiple RF chains. Furthermore, the communication unit 310 may include at least one antenna array including multiple antenna elements and perform beamforming.

The wire communication unit 310 may transmit and receive the signal as described above. Accordingly, all or a part of the communication unit 310 may be referred to as a “transmitter”, a “receiver”, or a “transceiver”. In addition, transmission and reception performed through a wireless channel, which is described below, may be understood as the above-described processing being performed by the communication unit 310. According to an embodiment, the communication unit 310 may include at least one transceiver.

The storage 320 may store data such as a basic program for operating the terminal, an application, configuration information, etc. The storage 320 may be configured as volatile memory, nonvolatile memory, or a combination of volatile memory and nonvolatile memory. The storage 320 may provide stored data upon a request from the controller 330. According to an embodiment, the storage 320 may include at least one memory.

The controller 330 may control the overall operation of the terminal. For example, the controller 330 may transmit and receive a signal through the communication unit 310. In addition, the controller 330 may record data in the storage 320 and read the recorded data therefrom. The controller 330 may perform the functions of a protocol stack required by the communication standard. To this end, the controller 330 may include at least one processor or microprocessor, or may be a part of the processor. According to an embodiment, the controller 330 may include at least one processor. In addition, a part of the communication unit 310 and/or the controller 330 may be referred to as a communication processor (CP).

The controller 330 may control the terminal to perform operations according to at least one of various embodiments described below. For example, the controller 330 may receive a downlink signal (a downlink control signal or downlink data) transmitted by the base station, through the transceiver (for example, the communication unit 310). In addition, for example, the controller 330 may determine a result of transmission of the downlink signal. The transmission result may include an acknowledgment (ACK), a negative ACK (NACK), or discontinuous transmission (DTX), and the like, as feedback on the transmitted downlink signal. In the disclosure, the transmission result may also be referred to as various terms including a downlink signal reception state, a reception result, a decoding result, HARQ-ACK information, etc. In addition, for example, the controller 330 may transmit an uplink signal to the base station through the transceiver as a response signal to the downlink signal. The uplink signal may explicitly or implicitly include the result of transmission of the downlink signal. For example, the controller 330 may include at least one of the HARQ-ACK information and/or channel state information (CSI) in the uplink control information and transmit the uplink control information to the base station through the communication unit 310. In this case, the uplink control information may be transmitted through the uplink data channel together with the uplink data, or may be transmitted to the base station through the uplink data channel without uplink data.

The controller 330 may perform a channel access procedure for an unlicensed band. For example, the communication unit 310 may receive signals transmitted in an unlicensed band, and the controller 330 may compare the strength of the received signal with a threshold determined according to a function value which is predefined or has a bandwidth as a factor, in order to determine whether the unlicensed band is in an idle state. The controller 330 may perform an access procedure for the unlicensed band in order to transmit a signal to the base station. In addition, the controller 330 may determine an uplink transmission resource for transmitting uplink control information by using at least one of uplink control information received from the base station and the channel access procedure result, and may transmit the uplink control information to the base station through the transceiver.

The controller 330 may receive higher-layer signaling including configuration information required to receive one piece of downlink control information (DCI) configured to allocate one or more data channels to one or more cells, from the base station through the communication unit 310. The controller 330 may also receive the DCI and interpret fields included in the DCI by using the configuration information. In addition, the controller 330 may transmit a data channel to the base station or receive a data channel from the base station according to information fields included in the DCI and the configuration information.

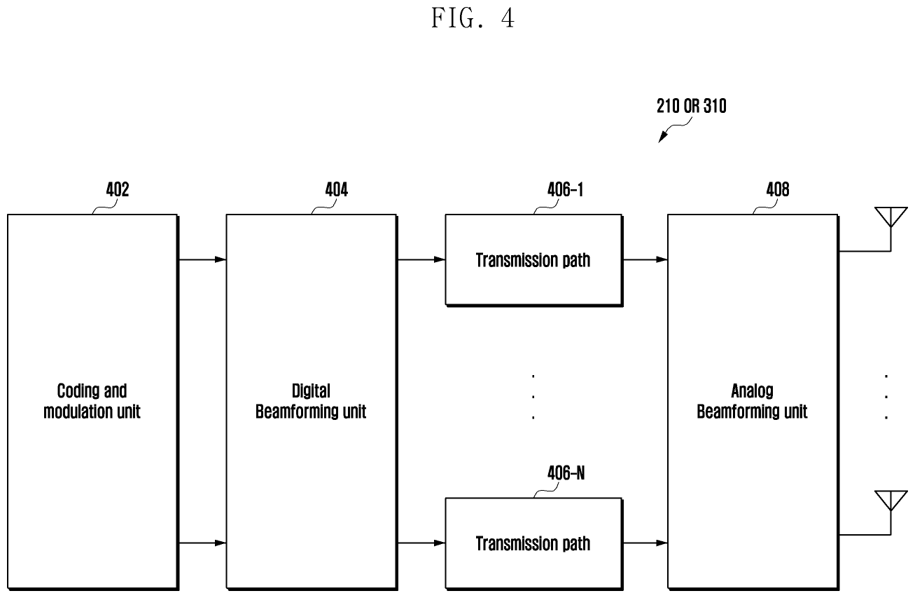

FIG. 4 illustrates a configuration of a communication unit in a wireless communication system according to an embodiment of the disclosure. FIG. 4 illustrates an example of a detailed configuration of the wireless communication unit 210 of FIG. 2 or the communication unit 310 of FIG. 3. Specifically, FIG. 4 may illustrate components for performing beamforming as a part of the wireless communication unit 210 of FIG. 2 or the communication unit 310 of FIG. 3.

Referring to FIG. 4, the wireless communication unit 210 or the communication unit 310 may include a coding and modulation unit 402, a digital beamforming unit 404, multiple transmission paths 406-1 to 406-N, and an analog beamforming unit 408.

The coding and modulation unit 402 may perform channel encoding. For the channel encoding, at least one of a low-density parity check (LDPC) code, a convolutional code, and a polar code may be used. The coding and modulation unit 402 may generate modulation symbols by performing constellation mapping for the encoded bits.

The digital beamforming unit 404 may perform beamforming for digital signals (for example, modulation symbols). To this end, the digital beamforming unit 404 may multiply the modulation symbols by beamforming weight values. Here, the beamforming weight values may be used to change the size and phase of the signal, and may be referred to as a “precoding matrix”, a “precoder”, or the like. The digital beamforming unit 404 may output the digitally beamformed (i.e., pre-coded) modulation symbols to the multiple transmission paths 406-1 to 406-N. In this case, according to a multiple-input multiple-output (MIMO) transmission scheme, the modulation symbols may be multiplexed, or the same modulation symbols may be provided through the multiple transmission paths 406-1 to 406-N.

The multiple transmission paths 406-1 to 406-N may convert the digitally beamformed digital signals into analog signals. To this end, each of the multiple transmission paths 406-1 to 406-N may include an inverse fast Fourier transform (IFFT) calculation unit, a cyclic prefix (CP) insertion unit, a DAC, and an up-conversion unit. The CP insertion unit is for an OFDM scheme, and may be omitted when another physical-layer scheme (e.g., an FBMC) is applied. The multiple transmission paths 406-1 to 406-N may provide independent signal-processing processes for multiple streams generated through the digital beamforming. Depending on the implementation scheme, some of the components of the multiple transmission paths 406-1 to 406-N may be used in common.

The analog beamforming unit 408 may perform beamforming on analog signals from the multiple transmission paths 406-1 to 406-N and connect the same to at least one antenna array including multiple antenna elements. To this end, the analog beamforming unit 408 may multiply analog signals by beamforming weight values. Here, the beamformed weight values may be used to change the size and phase of the signal. The analog beamforming unit 408 may be variously configured according to the structure of connection between the multiple transmission paths 406-1 to 406-N and antennas. For example, the multiple transmission paths 406-1 to 406-N may be connected to antenna arrays, respectively. In another example, the multiple transmission paths 406-1 to 406-N may be connected to a single antenna array. In another example, the multiple transmission paths 406-1 to 406-N may be adaptively connected to a single antenna array, or may be connected to two or more antenna arrays.

### Frame Structure

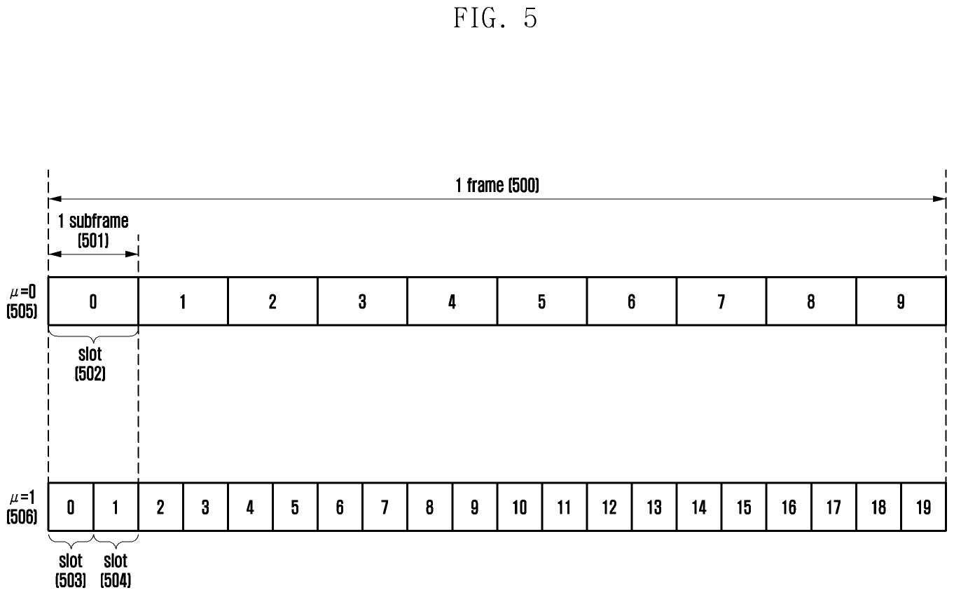

Hereinafter, a frame structure in the 5G system will be described in detail with reference to FIG. 5.

FIG. 5 illustrates structures of a frame, a subframe, and a slot in a 5G communication system according to an embodiment of the disclosure.

Referring to FIG. 5, a case of μ=0505 indicating 15 kilohertz (kHz) subcarrier spacing, a case of μ=1506 indicating 30 kHz subcarrier spacing, and an example of the structures of a frame 500, a subframe 501, and a slot 502, 503, or 504 are illustrated. In the 5G system as shown in FIG. 5, one frame 500 may be defined as 10 ms. One subframe 501 may be defined as 1 ms, and accordingly, one frame 500 may include a total of 10 subframes 501. One subframe 501 may include one or multiple slots. One slot may be defined as or may include 14 OFDM symbols. That is, the number of symbols per slot (N_{symb}^{slot}) is 14. In this case, the number of slots per subframe 501 (N_{symb}^{subframe,μ}) may vary according to a value (numerlogy) μ 505 or 506 indicating configuration for subcarrier spacing. For example, in the case of μ=0, one subframe 501 may include one slot 502, and, in the case of μ=1, one subframe 501 may include two slots 503 and 504.

The number of slots per subframe may vary according to the configuration value μ for subcarrier spacing, and accordingly, the number of slots per frame (Nₛₗₒₜ^{frame,μ}) may also vary. Nₛₗₒₜ^{subframe,μ} and Nₛₗₒₜ^{frame,μ} according to each subcarrier spacing configuration value μ may be defined as shown in [Table 1] below. In a case of μ=2, the terminal may additionally receive a configuration of a cyclic prefix from the base station through higher-layer signaling. Table 1 shows a frame structure according to each subcarrier spacing.

TABLE 1

| μ | Δf = 2μ · 15[kHz] | Cyclic prefix | N_{symb}^{slot} | Nₛₗₒₜ^{frameμ} | Nₛₗₒₜ^{subframeμ} |
|---|---|---|---|---|---|
| 0 | 15 | Normal | 14 | 10 | 1 |
| 1 | 30 | Normal | 14 | 20 | 2 |
| 2 | 60 | Normal, Extended | 14 | 40 | 4 |
| 3 | 120 | Normal | 14 | 80 | 8 |
| 4 | 240 | Normal | 14 | 160 | 16 |

Higher-layer signaling or a higher-layer signal in the disclosure may refer to at least one of terminal-specific or cell-specific radio resource control (RRC) signaling, packet data convergence protocol (PDCP) signaling, or a media access control (MAC) control element (CE). In addition, the higher-layer signaling or the higher-layer signal may also include system information commonly transmitted to multiple terminals, for example, a system information block (SIB), and may also include information (for example, physical broadcast channel (PBCH) payload) other than a master information block (MIB) from among information transmitted through a PBCH. In this case, the MIB may also be represented to be included in the higher-layer signaling or the higher-layer signal.

### Carrier Bandwidth

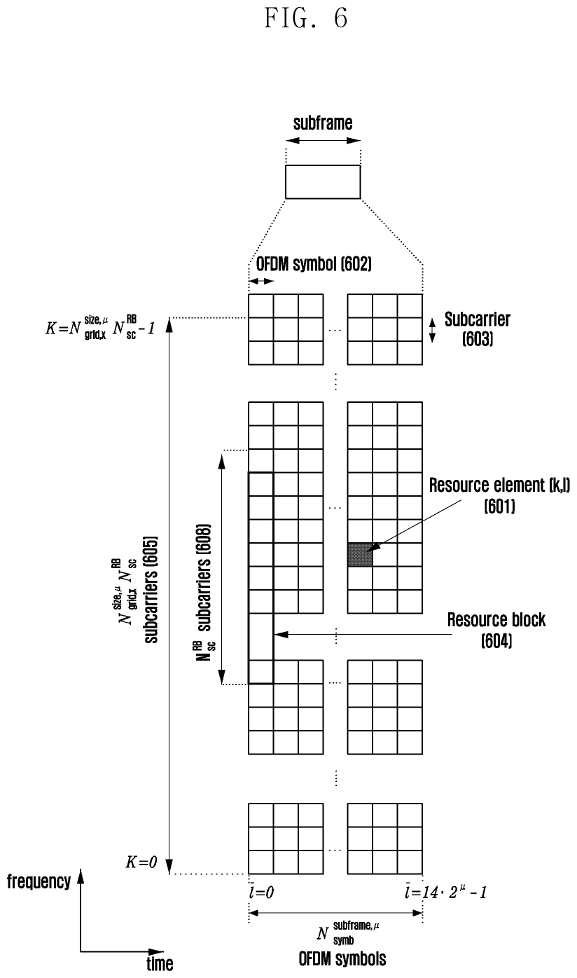

FIG. 6 illustrates a basic structure of a time-frequency area in a 5G communication system according to an embodiment of the disclosure. That is, FIG. 6 illustrates a basic structure of a time-frequency domain, which is a radio resource area in which a data or a control channel is transmitted in the 5G system.

Referring to FIG. 6, a horizontal axis indicates a time domain, and a vertical axis indicates a frequency domain. A basic unit of a resource in the time-frequency domain is a resource element (RE) 601 and may be defined as one orthogonal frequency division multiplexing (OFDM) symbol 602 in the time domain and one subcarrier 603 in the frequency domain. In the frequency domain, N_{sc}^{RB} (for example, 12) consecutive REs may constitute one resource block (RB) 604.

With respect to the subcarrier spacing configuration value μ and the carrier, one resource grid including N_{grid,x}^{size,μ}N_{sc}^{RB} subcarriers and N_{symb}^{subframe,μ} OFDM symbols may be defined to start from a common resource block (CRB) N_{grid,x}^{start,μ} indicated through higher-layer signaling, and there may be one resource grid for the given antenna port, subcarrier spacing configuration μ, and transmission direction (for example, the downlink, the uplink, and the sidelink).

The base station may transfer a carrier bandwidth N_{grid,x}^{size,μ} and a starting position N_{grid,x}^{start,μ} of the subcarrier spacing configuration μ for the uplink and the downlink to the terminal through higher-layer signaling (for example, higher-layer parameters “carrierBandwidth” and “offsetToCarrier”). In this case, the carrier bandwidth N_{grid,x}^{size,μ} may be configured by the higher-layer parameter “carrierBandwidth” for the subcarrier spacing configuration μ, and the starting position N_{grid,x}^{start,μ}, which is a frequency offset of a subcarrier having the lowest frequency among available resources of the carrier for Point A, may be configured by “offsetToCarrier” and may be represented by the number of RBs. In this case, N_{grid,x}^{size,μ} and N_{grid,x}^{start,μ} may also have a value in units of subcarriers. The terminal having received the parameters may identify the starting position and the size of the carrier bandwidth through N_{grid,x}^{size,μ} and N_{grid,x}^{start,μ}. An example of higher-layer signaling information transmitting N_{grid,x}^{size,μ} and N_{grid,x}^{start,μ} may be as shown in Table 2 (higher-layer signaling information element SCS-SpecificCarrier) below.

```
TABLE 2
SCS-SpecificCarrier ::= SEQUENCE {
offsetToCarrier INTEGER (0..2199),
subcarrierSpacing SubcarrierSpacing,
carrierBandwidth INTEGER (1..maxNrofPhysicalResourceBlocks),
    ...,
  [[
txDirectCurrentLocation INTEGER (0..4095) OPTIONAL --
Need S
]]
}
```

Here, Point A indicates a value for providing a common reference point for a resource block grid. In a case of a primary cell (PCell) downlink, the terminal may acquire Point A through the higher-layer parameter “offsetToPointA”, and, in any other cases, the terminal may acquire Point A through an absolute radio frequency channel number (ARFCN) configured by the higher-layer parameter “absoluteFrequencyPointA”. Here, “offsetToPointA” refers to a frequency offset between Point A and the lowest subcarrier of the lowest RB among RBs overlapping a synchronization signal/physical broadcast channel (SS/PBCH) selected or used by the terminal in an initial cell selection process, and is represented in units of RBs.

The common resource block (CRB) number or index increases in units of 1 in the value-ascending direction from zero in the frequency domain. In this case, for the subcarrier spacing μ, the center of subcarrier index 0 of the common resource block and Point A coincide. The frequency-domain common resource block index (n_{CRE}^{μ}) and an RE of the subcarrier spacing μ has a n_{CRB}^{μ}=└k/N_{sc}^{RE} ┘ relationship. Here, k indicates a value relatively defined with reference to Point A. That is, k=0 indicates Point A.

The physical resource block (PRB) of the subcarrier spacing μ is defined as an index or a number from zero to N_{BWP,i}^{size,μ}−1 in a bandwidth part (BWP). Here, i indicates a bandwidth part number or index. The relationship between the PRB (n_{PRB}^{μ}) and the CRB (n_{CRB}^{μ}) in the bandwidth part i is n_{CRB}^{μ}=n_{PRB}^{μ}+N_{BWP,i}^{start,μ}. Here, N_{BWP,i}^{start,μ} indicates the number of CRBs from CRB 0 to the first RB in which the bandwidth part i starts.

### BWP

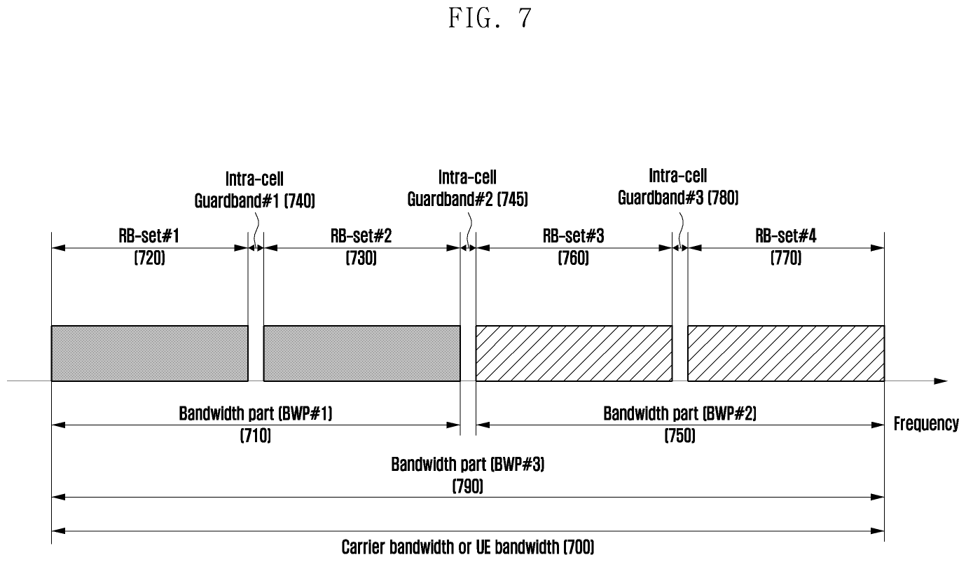

Hereinafter, a bandwidth part configuration in the 5G communication system will be described in detail with reference to FIG. 7.

FIG. 7 illustrates an example of a configuration of a bandwidth part and an intra-cell guard-band in a 5G communication system according to an embodiment of the disclosure.

Referring to FIG. 7, in a carrier bandwidth part or a terminal bandwidth (UE bandwidth) 700, multiple bandwidth parts, i.e., bandwidth part #1 (BWP #1) 710, bandwidth part #2 (BWP #2) 750, and bandwidth part #3 (BWP #3) 790, may be configured. Bandwidth part #3790 occupies the entire UE bandwidth 700. Bandwidth part #1 710 and bandwidth part #2 750 may occupy a lower half and an upper half of the UE bandwidth 700, respectively.

The base station may configure one or multiple bandwidth parts for the terminal in the uplink and the downlink, and one or more of lower-layer parameters may be configured for each bandwidth part. In this case, the configuration of the bandwidth part may be independent between the uplink and the downlink. Table 3 below is an example of a higher-layer signaling information element BWP for each bandwidth part.

TABLE 3

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, |
| n1, n2, n3, n4, n5}, | |
| cyclicPrefix | ENUMERATED { extended } |
| } | |

Here, “bwp-Id” indicates to a bandwidth part identifier, “locationAndBandwidth” indicates a bandwidth and a frequency-domain location of the bandwidth part, “subcarrierSpacing” indicates subcarrier spacing used in the bandwidth part, and “cyclicPrefix” indicates whether an extended cyclic prefix (CP) is used or a normal CP is used in the bandwidth part.

In addition to the parameters above, various parameters related to the bandwidth part may be configured for the terminal. The parameters may be transferred to the terminal by the base station through higher-layer signaling, for example, RRC signaling. Within the given time, at least one of the configured one or more bandwidth parts may be activated. The activation indication for the configured bandwidth part may be semi-statically transferred to the terminal by the base station through RRC signaling, or may be dynamically transferred through downlink control information (DCI) used for scheduling of a physical downlink shared channel (PDSCH) or a physical uplink shared (PUSCH).

According to an embodiment, the terminal before being RRC-connected may be configured by the base station with an initial bandwidth part (initial BWP) for initial access through a master information block (MIB). More specifically, the terminal may receive configuration information of a control resource set (CORESET) and a search space in which a physical downlink control channel (PDCCH) can be transmitted, through the MIB in the initial access process. In this case, each of the control resource set and search space configured through the MIB may be considered as identity (ID) 0. The base station may notify the terminal of one or more information pieces of frequency allocation information, time allocation information, and numerology for control resource set #0 through the MIB. Here, the numerology may include at least one of subcarrier spacing and a CP. The CP may refer to at least one of the length of the CP or information (e.g., normal or extended) corresponding to the length of the CP.

In addition, the base station may notify the terminal of configuration information of monitoring periodicity and occasion for control resource set #0, i.e., configuration information for search space #0, through the MIB. The terminal may consider a frequency domain configured to resource set #0 acquired from the MIB as an initial bandwidth part for initial access. In this case, the identity (ID) of the initial bandwidth part may be considered as 0.

The configuration of the BWP supported by the 5G may be used for various purposes.

According to an embodiment, when a bandwidth supported by the terminal is smaller than a system bandwidth, data transmission or reception of the terminal for the system bandwidth may be supported through a bandwidth part configuration. For example, the base station may configure the frequency-domain location of the bandwidth part for the terminal so that the terminal can transmit or receive data in a particular frequency location within the system bandwidth.

According to an embodiment, for the purpose of supporting different numerologies, the base station may configure multiple bandwidth parts for the terminal. For example, to support data transmission and reception using both 15 kHz subcarrier spacing and 30 kHz subcarrier spacing for the terminal, the base station may configure two bandwidth parts with 15 kHz subcarrier spacing and 30 kHz subcarrier spacing, respectively. The different bandwidth parts may be frequency division multiplexed, and for data transmission or reception with particular subcarrier spacing, a bandwidth part configured with the particular subcarrier spacing may be activated.

According to an embodiment, for the purpose of reducing power consumption of the terminal, the base station may configure bandwidth parts having different bandwidth sizes for the terminal. For example, when a terminal supports a very large bandwidth, for example, a 100 MHz bandwidth, and always transmits or receives data in the corresponding bandwidth, the terminal may consume a great amount of power. Especially in a situation where there is no traffic, monitoring an unnecessary downlink control channel in the large 100 MHz bandwidth may be very inefficient in terms of power consumption. To reduce the power consumption of the terminal, the base station may configure a bandwidth part with a relatively small bandwidth, for example, a 20 MHz bandwidth part, for the terminal. In a situation where there is no traffic, the terminal may perform a monitoring operation in the 20 MHz bandwidth part, and when data is generated, the terminal may transmit or receive the data in the 100 MHz bandwidth part under the indication from the base station.

As described above, terminals before being RRC-connected may receive configuration information for the initial bandwidth part through the MIB in an initial access process. More specifically, the terminal may be configured with a control resource set (CORESET) for a PDCCH through the MIB of a PBCH. The bandwidth of the control resource set configured through the MIB may be considered as the initial downlink bandwidth part, and the terminal may receive a physical downlink shared channel (PDSCH) on which the SIB is transmitted, through the initial bandwidth part. Specifically, the terminal may detect a PDCCH from the search space and the control resource set in the initial bandwidth part configured through the MIB, receive remaining system information (RMSI) or system information block 1 (SIB1) required for initial access, through a PDSCH scheduled by the PDCCH, and acquire configuration information relating to the uplink initial bandwidth part through the SIB1 (or RMSI). The initial BWP may also be used for other system information (OSI), paging, or random access, in addition to the reception of the SIB.

When one or more bandwidth parts are configured for the terminal, the base station may indicate, to the terminal, a bandwidth part switch by using a bandwidth part indicator field in the DCI.

For example, in FIG. 7, when the currently active bandwidth part of the terminal is bandwidth part #1 710, the base station may indicate bandwidth part #2 750 to the terminal by using the bandwidth part indicator in DCI, and the terminal may perform a bandwidth part switch to the bandwidth part #2 750 indicated according to the bandwidth part indicator in the received DCI.

As described above, the DCI-based bandwidth switch may be indicated by the DCI which schedules a PDSCH or a PUSCH. And thus, when the terminal receives a request to switch the bandwidth part, the terminal should be able to receive or transmit the PDSCH or the PUSCH scheduled by the DCI without difficulty in the switched bandwidth part. To this end, requirements for a delay time (TBWP) required when the bandwidth part switch are specified in the standard and may be defined as follows, for example.

TABLE 4

| | | BWP switch delay TBWP (slots) | |
|---|---|---|---|
| μ | NR Slot length (ms) | Type 1^{Note 1} | Type 2^{Note 1} |
| 0 | 1 | 1 | 3 |
| 1 | 0.5 | 2 | 5 |
| 2 | 0.25 | 3 | 9 |
| 3 | 0.125 | 6 | 17 |

Note 1:
Depends on UE capability.
Note 2:
If the BWP switch involves changing of SCS, the BWP switch delay is determined by the larger one between the SCS before BWP switch and the SCS after BWP switch.

The requirements for the bandwidth part switch delay time support type 1 or type 2 depending on the capability of the terminal. The terminal may report a supportable bandwidth part delay time type to the base station.

When the terminal receives the DCI including the bandwidth part switch indicator in slot n according to the requirements for the bandwidth part switch delay time, the terminal may complete a switch to a new bandwidth part indicated by the bandwidth part switch indicator at a time no later than slot n+T_{BWP}, and may perform transmission or reception for a data channel scheduled by the corresponding DCI in the switched new bandwidth part. When the base station intends to schedule the data channel to the new bandwidth part, the base station may determine a time-domain resource assignment for the data channel by taking into account the bandwidth part switch delay time (T_{BWP}) of the terminal. That is, in a method for determining time domain resource assignment for a data channel when the base station schedules the data channel to the new bandwidth part, the base station may schedule the corresponding data channel after the bandwidth part switch delay time. Accordingly, the terminal may not expect the DCI indicating the bandwidth part switch to indicate a slot offset (K0 or K2) having a value less than the bandwidth part switch delay time (T_{BWP}).

When the terminal receives the DCI (for example, DCI format 1_1 or 0_1) indicating the bandwidth part switch, the terminal may not perform transmission or reception during a time interval from the third symbol of the slot where the PDCCH including the DCI is received to a start symbol of the slot indicated by the slot offset (K0 or K2) indicated by the time-domain resource assignment field in the DCI. For example, when the terminal has received the DCI indicating the bandwidth part switch in slot n and the slot offset indicated by the DCI is K, the terminal may not perform transmission or reception from the third symbol of slot n to a symbol prior to slot n+K (i.e., the last symbol of slot n+K−1).

### Intra-Cell Guard-Band

The terminal may be configured with an intra-cell guard-band for one or more cells (or carriers). In this case, the intra-cell guard-band may be configured for each of a downlink guard-band and an uplink guard-band. In FIG. 7, an example in which the carrier bandwidth or the terminal bandwidth (or UE bandwidth) 700 is configured with multiple intra-cell guard-bands, i.e., intra-cell guard-band #1 740, intra-cell guard-band #2 745, and intra-cell guard-band #3 780. More specifically, the terminal may be configured with N_{RB-set,x}−1 uplink/downlink intra-cell guard-bands in a cell or a carrier through the higher-layer signaling, “IntraCellGuardBand-r16” which can be configured as below, for example. Here, x=DL or UL. Table 5 shown an example of a higher-layer signaling information element, IntraCellGuardBand-r16, which configures the intra-cell guard-band.

TABLE 5

| | |
|---|---|
| IntraCellGuardBand-r16 | ::= SEQUENCE (SIZE (1..ffsValue)) OF |
| GuardBand-r16 | |
| GuardBand-r16 | ::= SEQUENCE { |
| startCRB-r16 | INTEGER (0..ffsValue), |
| nrofCRBs-r16 | INTEGER (1..ffsValue) |
| } | |

Here, “startCRB” indicates the start CRB index (GB_{s,x}^{start,μ}) in the intra-cell guard-band, and “nrofCRBs” indicates the length of the intra-cell guard-band and may be represented as the number (N) of CRBs or the number (N) of PRBs. In this case, “nrofCRBs” may be a value indicating the last CRB index (GB_{s,x}^{end,μ}) in the intra-cell guard-band. In other words, the “GuardBand” may include one or more values of startCRB and nrofCRBs, and the first value among every two values may mean the lowest CRB index GB_{s,x}^{start,μ} in the intra-cell guard-band, and the second value may mean the highest CRB index GB_{s,x}^{end,μ} in the intra-cell guard-band. In this case, GB_{s,x}^{end,μ} may be determined according to GB_{s,x}^{end,μ}=GB_{s,x}^{start,μ}+N. Here, the CRB index may be also represented by the PRB index. The terminal may also determine the number (N_{RB-set,x}−1) of intra-cell guard-bands configured by the base station by using the number of pairs (startCRB and nrofCRBs) included in the “GuardBand” or the sequence length of the “GuardBand” (for example, the sequence length/2). In this case, the terminal may also be configured through the “IntraCellGuardBand-r16” that there is no uplink/downlink intra-cell guard-band in a cell or a carrier, or that the guard-band is 0. For example, when “startCRB-r16” has at least a negative value such as −1, or other numbers not an integer, the terminal may determine through the configuration that there is no intra-cell guard-band in a cell or a carrier.

As described above, the terminal having been configured with the intra-cell guard-band may classify a resource area remaining after excluding the intra-cell guard-band in the carrier or the configured bandwidth part as a resource set (for example, RB-set) or a resource area including N_{RB-set} RBs, and may perform uplink/downlink transmission or reception by using a resource included in the resource set. In this case, a resource area of each resource set may be determined as follows.
Start CRB index of first resource set (resource set index 0): RB_{0,x}^{start,μ}=N_{grid,x}^{start,μ}
Last CRB index of last resource set (resource index N_{RB-set}): RB_{N}_{_{RB-set}}_{,x}^{start,μ}=N_{grid,x}^{start,μ}+N_{grid,x}^{size,μ}
Start CRB index of resource set except for above resource set: RB_{s+1,x}^{start,μ}=GB_{s,x}^{end,μ}+1
End CRB index of resource set except for above resource set: RB_{s,x}^{end,μ}=GB_{s,x}^{start,μ}−1

Here, s=0, 1, . . . , N_{RB-set,x}−1, and N_{grid,x}^{start,μ} and N_{grid,x}^{size,μ}, which are the first available RB and an available bandwidth of the carrier according to the subcarrier spacing configuration, may be configured through higher-layer signaling.

FIG. 7 shows an example in which the carrier bandwidth or the terminal bandwidth (UE bandwidth) 700 are configured with three intra-cell guard-bands and four resource sets (N_{RB-set}=4), i.e., resource set #1 720, resource set #2 730, resource set #3 760, and resource set #4 770.

The terminal may perform uplink/downlink transmission or reception by using the intra-cell guard-band and the resource included in the resource set. For example, when an uplink/downlink transmission or reception resource configured or scheduled by the base station is allocated within two consecutive resource sets, the terminal may perform uplink/downlink transmission or reception by using the intra-cell guard-band included between the resource sets.

When the terminal has failed to be configured with the intra-cell guard-band through the higher-layer signaling, “intraCellGuardBandx” (here, x=DL or UL), the terminal may determine the intra-cell guard-band and the resource set resource area by using the pre-defined intra-cell guard-band. In this case, the intra-cell guard-band may be pre-defined according the subcarrier spacing and the size of the bandwidth or the bandwidth part. In addition, the intra-cell guard-band may be pre-defined independently with respect to the downlink and the uplink, and the downlink intra-cell guard-band may be identical to the uplink intra-cell guard-band. Here, when the intra-cell guard-band is pre-defined, it may mean that the start CRB index GB_{s,x}^{start,μ} in the intra-cell guard-band, the last CRB index GB_{s,x}^{end,μ} in the intra-cell guard-band, the lowest CRB index GB_{s,x}^{start,μ} in the intra-cell guard-band, or the highest CRB index GB_{s,x}^{end,μ} in the intra-cell guard-band is pre-defined.

According to an embodiment, an example in which the terminal is configured with at least one guard-band among uplink/downlink guard-bands in a particular cell or carrier is as follows. In a case of a cell for performing communication through an unlicensed band, the base station may configure one or more guard-bands in the bandwidth or the bandwidth part according to the size of the channel in the unlicensed band, etc. For example, a 5 GHz unlicensed band includes multiple 20 MHz-sized channels and guard-bands may exist between the corresponding channels. Therefore, when the base station and the terminal perform communication through a bandwidth part or a bandwidth larger than 20 MHz, one or more guard-bands may be configured in the bandwidth or the bandwidth part.

For example, in a case in which the base station and the terminal perform communication through a 20 MHz-sized channel in the unlicensed band, when the size of at least one bandwidth part among bandwidth parts 710, 750, and 790 configured for the terminal by the base station is greater than 20 MHz, the terminal may be configured with one or more intra-cell guard-bands, and may be configured to include multiple resource sets in which the size of each bandwidth part is 20 MHz, according to the intra-cell guard-band configuration. For example, with respect to bandwidth part #1 710 in FIG. 7, the terminal may be configured with two resource sets, resource set #1 720 and resource set #2 730 and one intra-cell guard-band, intra-cell guard-band #1 740. The base station and the terminal may perform a channel access procedure (or listen-before-talk (LBT)) for each resource set and perform uplink/downlink transmission or reception by using a resource set that has succeeded in channel access. In this case, when two consecutive resource sets (for example, resource set #1 720 and resource set #2 730) has succeeded in channel access, a resource in intra-cell guard-band #1 740 included between the resource sets can be also used for uplink/downlink transmission or reception. When at least one resource set among two consecutive resource sets (for example, resource set #1 720 and resource set #2 730) has failed in channel access, a resource in intra-cell guard-band #1 740 included between the resource sets cannot be used for uplink/downlink transmission or reception.

### SS/PBCH Block

A synchronization signal (SS)/physical broadcast channel (PBCH) block in 5G will now be described.

An SS/PBCH block may refer to a physical layer channel block including a primary SS (PSS), a secondary SS (SSS), and a PBCH, which are defined as follows:
PSS: A PSS is a reference signal for downlink time/frequency synchronization, which provides a part of information of a cell ID.
SSS: An SSS is a reference signal for downlink time/frequency synchronization, which provides the rest of the cell ID information not provided by the PSS. Additionally, the SSS may also serve as a reference signal (RS) for demodulation of the PBCH.
PBCH: A PBCH provides essential system information required for transmission or reception of a data channel and a control channel for a terminal. The essential system information may include search-space-related control information indicating radio resource mapping information of the control channel, scheduling control information for an extra data channel that transmits system information, and the like.
SS/PBCH block: An SS/PBCH block is a combination of a PSS, an SSS, and a PBCH. One or more SS/PBCH blocks may be transmitted in 5 ms, and each SS/PBCH block may be distinguished by an index.

The terminal may detect the PSS and the SSS in the initial access process, and decode the PBCH. The terminal may obtain the MIB from the PBCH and may be configured with control resource set #0 (this may correspond to a control resource set having a control resource set index of 0) accordingly. The terminal may monitor control resource set #0, assuming that demodulation reference signal (DMRS) transmitted in control resource set #0 are quasi-co-located (QCL) with the selected SS/PBCH block (or the SS/PBCH block that has successfully performed PBCH decoding). The terminal may obtain system information as downlink control information transmitted in control resource set #0. The terminal may obtain random-access channel (RACH)-related configuration information required for initial access from the received system information. The terminal may transmit a physical RACH (PRACH) to the base station in consideration of the selected SS/PBCH index, and the base station having received the PRACH may obtain an SS/PBCH block index selected by the terminal. The base station may identify a block that the terminal selected from among respective SS/PBCH blocks and may identify that control resource set #0 associated with the selected block is monitored.

### DCI

Next, downlink control information (DCI) in the 5G system will be described in detail.

In the 5G system, scheduling information for uplink data (or a physical uplink shared channel (PUSCH)) or downlink data (or a physical downlink shared channel (PDSCH)) is transferred from the base station to the terminal via DCI. The terminal may attempt to monitor or detect a fallback DCI format and a non-fallback DCI format for the PUSCH or the PDSCH. The fallback DCI format may include fields pre-defined between the base station and the terminal, and the non-fallback DCI may include configurable fields.

The DCI may be transmitted via a physical downlink control channel (PDCCH) after going through channel coding and modulation processes. Cyclic redundancy check (CRC) may be attached to a DCI payload, and the CRC may be scrambled by a radio network temporary identifier (RNTI) that corresponds to the identity of the terminal. Depending on the use of the DCI, for example, terminal-specific (UE-specific) data transmission, a power control command, a random-access response, or the like, different RNTIs may be used. That is, the RNTI is transmitted not explicitly but included in a CRC calculation process and transmitted. When the DCI transmitted on the PDCCH is received, the terminal may check CRC by using an allocated RNTI, and determine that the corresponding DCI is transmitted to the terminal when the CRC check result is correct.

For example, DCI that schedules a PDSCH for system information (SI) may be scrambled by an SI-RNTI. DCI that schedules a PDSCH for a random-access response (RAR) message may be scrambled by an RA-RNTI. DCI that schedules a PDSCH for a paging message may be scrambled by a P-RNTI. DCI that notifies of a slot format indicator (SFI) may be scrambled by an SFI-RNTI. DCI that notifies of a transmit power control (TPC) may be scrambled by a TPC-RNTI. DCI that schedules a UE-specific PDSCH or PUSCH may be scrambled by a cell RNTI (C-RNTI).

DCI format 0_0 may be used for the fallback DCI that schedules the PUSCH, and in this case, the CRC may be scrambled by at least one of C-RNTI, configured scheduling (CS)-RNTI, and modulation coding scheme (MCS)-C-RNTI. DCI format 0_0 having a CRC scrambled by at least one of the C-RNTI, CS-RNTI, and MCS-C-RNTI may include, for example, information below.
Identifier for DCI formats: This is an identifier for identifying a DCI format. For example, in a terminal having received DCI through 1-bit identifier, when the identifier value is 0, the DCI format is a UL DCI format (for example, DCI format 0_1), and when the identifier value is 1, the DCI format is a DL DCI format (for example, DCI format 1_0).
Frequency domain resource assignment: This is a resource allocation type-1 scheme and includes ┌log₂(N_{RB}^{UL,BWP}(N_{RB}^{UL,BWP}+1)/2)┐ bits indicating RBs corresponding to allocated frequency domain resources. Here, when the terminal monitors DCI format 0_0 in the common search space, N_{RB}^{UL,BWP} indicates the size of the initial uplink bandwidth part, and when the terminal monitors DCI format 0_0 in the terminal-specific search space, N_{RB}^{UL,BWP} indicates the size of the currently activated uplink bandwidth part. In other words, a bandwidth part for determining the size of a frequency domain resource allocation field may vary according to a search space in which a fallback DCI format is transmitted.

In an embodiment, when PUSCH hopping is performed, N_{UL_hop} most significant bits (MSBs) among ┌log₂(N_{RB}^{UL,BWP}(N_{RB}^{UL,BWP}+1)/2)┐ bits may be used to indicate a frequency offset. Here, when N_{UL_hop}=1, two offsets are configured via higher-layer signaling, when N_{UL_hop}=2, four offsets are configured via higher-layer signaling, and ┌log₂(N_{RB}^{UL,BWP}(N_{RB}^{UL,BWP}+1)/2)┐−N_{UL_hop} bits indicate a frequency domain resource area allocated according to resource allocation type 1 below.

According to an embodiment, when no PUSCH hopping is performed, ┌log₂(N_{RB}^{UL,BWP}(N_{RB}^{UL,BWP}+1)/2)┐ bits provide a frequency domain resource area allocated according to resource allocation type 1 below.
Time domain resource assignment: This corresponds to 4 bits and indicates an row index of a time domain resource allocation table including a PUSCH mapping type, a PUSCH transmission slot offset, a PUSCH start symbol, and the number of PUSCH transmission symbols. The time domain resource allocation table may be configured via higher-layer signaling or may be pre-configured between the base station and the terminal.
Frequency hopping flag: This corresponds to 1 bit and indicates whether to perform (enable) PUSCH hopping or not to perform (disable) the PUSCH hopping.
Modulation and coding scheme (MCS): This indicates a modulation and coding scheme used for data transmission.
New data indicator (NDI): This indicates HARQ initial transmission or retransmission.
Redundancy version (RV): This indicates the redundancy version of the HARQ.
HARQ process number: This indicates the process number of the HARQ.
TPC command: This indicates a transmission power control command for the scheduled PUSCH.
Padding bit: This is a field for adjusting the size (the number of total bits) of a DCI format to be identical to those of other DCI formats (for example, DCI format 1_0), and is inserted with zero if necessary.
UL/SUL indicator: This correspond to 1 bit. When a cell has two or more ULs and the size of DCI format 1_0 before padding bit addition is greater than the size of DCI format 0_0 before padding bit addition, the cell has a 1-bit UL/SUL indicator, and otherwise, the UL/SUL indicator does not exist or corresponds to 0 bit. If the UL/SUL indicator exists, the UL/SUL indicator is located in the last bit of DCI format 0_0 after the padding bit.
ChannelAccess-CPext: This corresponds to 2 bits and indicates a channel access type and CP extension in a cell operating in an unlicensed band. In a case of a cell operating in a licensed band, ChannelAccess-CPext does not exist or corresponds to 0 bit.

For DCI formats other than DCI format 0_0, the 3GPP standard documents is referred to.

### Time Domain Resource Allocation

Hereinafter, time domain resource allocation for a data channel in the 5G communication system will be described.

The base station may configure the terminal with a table of time domain resource allocation for a downlink data channel (a physical downlink shared channel (PDSCH)) and an uplink data channel (a physical uplink shared channel (PUSCH)) through higher-layer signaling (for example, RRC signaling), or a table for time domain resource allocation pre-defined between the base station and the terminal may be used as shown in Table 6 below.

For example, in a case of fallback DCI, the terminal uses a table pre-defined as shown in Table 6, and in a case of non-fallback DCI, the terminal uses a table configured through higher-layer signaling.

TABLE 6

| Row index | PUSCH mapping type | K₂ | S | L |
|---|---|---|---|---|
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

In this case, in order to perform time domain resource allocation configured through higher-layer signaling, for the PDSCH, a table including up to 16 (maxNrofDL-Allocations=16) entries may be configured, and for the PUSCH, a table including up to 16 (maxNrofUL-Allocations=16) entries may be configured. Each table above may include a PDCCH-to-PDSCH slot timing (corresponding to a time interval in units of slots between a time point at which a PDCCH is received and a time point at which a PDSCH scheduled by the received PDCCH is transmitted, and denoted as “K₀”), a PDCCH-to-PUSCH slot timing (corresponding to a time interval in units of slots between a time point at which a PDCCH is received and a time point at which a PUSCH scheduled by the received PDCCH is transmitted, and denoted as “K₂”), the position (S) and the length (L) of a start symbol in the slot, in which the PDSCH or the PUSCH is scheduled, a mapping type of the PDSCH or the PUSCH, etc.

In a case where the higher-layer signaling is used, for example, an information element such as a PDSCH-TimeDomainResourceAllocationList information element and a PUSCH-TimeDomainResourceAllocation information element in Table 7 and Table 8 below may be notified to the terminal from the base station.

TABLE 7
PDSCH-TimeDomainResourceAllocation ::= SEQUENCE {
k0 INTEGER(0..32) OPTIONAL, -- Need S
mappingType ENUMERATED {typeA, typeB},
startSymbolAndLength INTEGER (0..127)
}

TABLE 8
PUSCH-TimeDomainResourceAllocation ::= SEQUENCE {
k2 INTEGER(0..32) OPTIONAL, -- Need S
mappingType ENUMERATED {typeA, typeB},
startSymbolAndLength INTEGER (0..127)
}

Here, “k0” indicates a PDCCH-to-PDSCH timing as an offset in units of slots, “k2” indicates a PDCCH-to-PUSCH timing as an offset in units of slots, “mappingType” indicates a mapping type of a PDSCH or a PUSCH, and “startSymbolAndLength” indicates a start symbol and the length of the PDSCH or the PUSCH.

The base station may notify the terminal of one of the time domain resource allocation table entries via L1 signaling. For example, a “time domain resource allocation” field in the DCI may be indicated. The terminal may acquire time domain resource allocation for the PDSCH or the PUSCH from the base station according to a field in the received DCI.

### Frequency Domain Resource Allocation

Hereinafter, frequency domain resource allocation for a data channel in the 5G communication system will be described.

There are two types of frequency domain resource allocation schemes supported for a downlink data channel (PDSCH) and an uplink data channel (PUSCH), i.e., resource allocation type 0 and resource allocation type 1.

Resource allocation type 0 corresponds to a scheme of allocating a resource in units of resource block groups (RBGs) including P consecutive RBs, and may be notified in a bitmap type to the terminal by the base station. In this case, the RBG may include a set of consecutive virtual RBs (VRBs), and the RBG size P (nominal RBG size P) may be determined according to a value configured as a higher-layer parameter, “rbg-Size”, and a value of the size of a bandwidth part, defined in Table 9 below.

TABLE 9

| Bandwidth | Config- | Config- |
|---|---|---|
| Part Size | uration 1 | uration 2 |
| 1-36 | 2 | 4 |
| 37-72 | 4 | 8 |
| 73-144 | 8 | 16 |
| 145-275 | 16 | 16 |

A total number (N_{REG}) of RBGs of bandwidth part i having a N_{BWP,i}^{size} size is N_{RBG}=┌(N_{BWP,i}^{size}+(N_{BWP,i}^{start} mod P))/P┐. Here, the size of the first RBG is RBG₀^{size}=P−N_{BWP,i}^{start} mod P. If (N_{BWP,i}^{start}+N_{BWP,i}^{size}) mod P>0, the size of the last RBG RBGₗₐₛₜ^{size} is RBGₗₐₛₜ^{size}=(N_{BWP,i}^{start}+N_{BWP,i}^{size}) mod P, and otherwise, RBGₗₐₛₜ^{size} is P. The size of all other RBGs is P. Bits of a bitmap having the size of N_{RBG} bits may correspond to RBGs, respectively. The RBGs may be assigned with indices in an ascending order of the frequency from the lowest frequency position of a bandwidth part. With respect to a N_{RBG} number of RBGs in a bandwidth part, RBG #0 to RBG #(N_{RBG}−1) may be mapped from the MSB to the LSB of an RBG bitmap. When a particular bit value in a bitmap is 1, the terminal may determine that an RBG corresponding to the bit value has been allocated, and when a particular bit value in a bitmap is 0, the terminal may determine that an RBG corresponding to the bit value has not been allocated.

Resource allocation type 1 is a scheme of allocating a resource according to a starting position and the length of consecutively allocated VRBs, and in this case, interleaving or non-interleaving may be additionally applied to the consecutively allocated VRBs. A resource allocation field of resource allocation type 1 may be configured by a resource indication value (RIV), and the RIV may be configured by the starting point (RBₛₜₐᵣₜ) of a VRB and the length (L_{RBs}) of consecutively allocated RBs. RBₛₜₐᵣₜ may indicate an index of the first PRB in which resource allocation starts, and L_{RBs} may indicate the length or the number of the consecutively allocated PRBs. More specifically, an RIV in a bandwidth part having the size of N_{BWP}^{size} may be defined as follows

$$If ( {L}_{RBs} - 1 ) \leq ⌊ \frac{{N}_{BWP}^{size}}{2} ⌋ then RIV = {N}_{BWP}^{size} ( {L}_{RBs} - 1 ) + {RB}_{start}$$

$$Else , RIV = {N}_{BWP}^{size} ( {N}_{BWP}^{size} - {L}_{RBs} - 1 ) + ( {N}_{BWP}^{size} - 1 - {RB}_{start} )$$

$$where , {L}_{RBs} \geq 1 and shall not exeed {N}_{BWP}^{size} - {RB}_{start} .$$

In this case, N_{BWP}^{size} may vary depending on a search space in which a fallback DCI format (for example, DCI format 0_0 or DCI format 1_0) is transmitted. For example, when DCI format 0_0 corresponding to a fallback DCI format among DCI (i.e., uplink grant (UL grant)) configuring or scheduling uplink transmission is transmitted in a common search space (CSS), the initial uplink bandwidth part size, N_{BWP,0}^{size}, or N_{BWP}^{initial} or N_{BWP} may be used for N_{BWP}^{size}. Similarly, when DCI format 1_0 corresponding to a fallback DCI format among DCI configuring or scheduling downlink reception is transmitted in a common search space (CSS), N_{BWP}^{size} or N_{BWP}^{initial} corresponds to the size of control resource set #0 in a case where control resource set #0 is configured for a cell, and corresponds to the size of the initial downlink bandwidth part in a case where control resource set #0 is not configured for the cell.

When DCI format 0_0 or DCI format 1_0 corresponding to a fallback DCI format is transmitted in a UE-specific search space (USS), or when the size of the fallback DCI format transmitted in the UE-specific search space is determined according to the size of the initial uplink bandwidth part or the initial downlink bandwidth part and the DCI is applied to another active bandwidth part having the size of N_{BWP}^{active}, an RIV corresponds to RBₛₜₐᵣₜ=0, K, 2K, . . . , (N_{BWP}^{initial}−1)K, N_{BWP}^{initial}, and L_{RBs}=K, 2K, . . . , N_{BWP}^{initial}K, and is defined as follows.

If (L′_{RBs}−1)≥└N_{BWP}^{initial}/2┘ then RIV=N_{BWP}^{initial}(L′_{RBs}−1)+RB′ₛₜₐᵣₜ

Else, RIV=N_{BWP}^{initial}(N_{BWP}^{initial}−L′_{RBs}−1)+(N_{BWP}^{initial}−1−RB′ₛₜₐᵣₜ)

where, L′_{RBs}=L_{RBs}/K,RB′ₛₜₐᵣₜ=RBₛₜₐᵣₜ/K,

L′_{RBs} shall not exceed N_{BWP}−RB′ₛₜₐᵣₜ.

In this case, if N_{BWP}^{active}>N_{BWP}^{initial}, K is the largest value satisfying K≤└N_{BWP}^{active}/N_{BWP}^{initial}┘ among set {1, 2, 4, 8}

The base station may configure, for the terminal, a resource allocation type through higher-layer signaling. For example, a higher-layer parameter resourceAllocation may be configured to be one value among resourceAllocationType0, resourceAllocationType1, or dynamicSwitch. If both resource allocation types 0 and 1 are configured for the terminal or the-higher layer parameter resourceAllocation is configured to be dynamicSwitch, the most significant bit (MSB) in a resource allocation indication field in a DCI format indicating scheduling may indicate resource allocation type 0 or 1, resource allocation information may be indicated through the bits remaining after excluding the MSB according to the indicated resource allocation type, and the terminal may interpret resource allocation field information of the DCI according to the indication. If one of resource allocation type 0 and 1 is configured for the terminal or the higher-layer parameter resourceAllocation is configured to be resourceAllocationType0 or resourceAllocationType1, a resource allocation indication field in a DCI format indicating scheduling may indicate resource allocation information according to the configured resource allocation type, and the terminal may interpret resource allocation field information of the DCI according to the indication.

### CORESET

Hereinafter, a downlink control channel in the 5G communication system will be described in more detail with reference to the drawings.

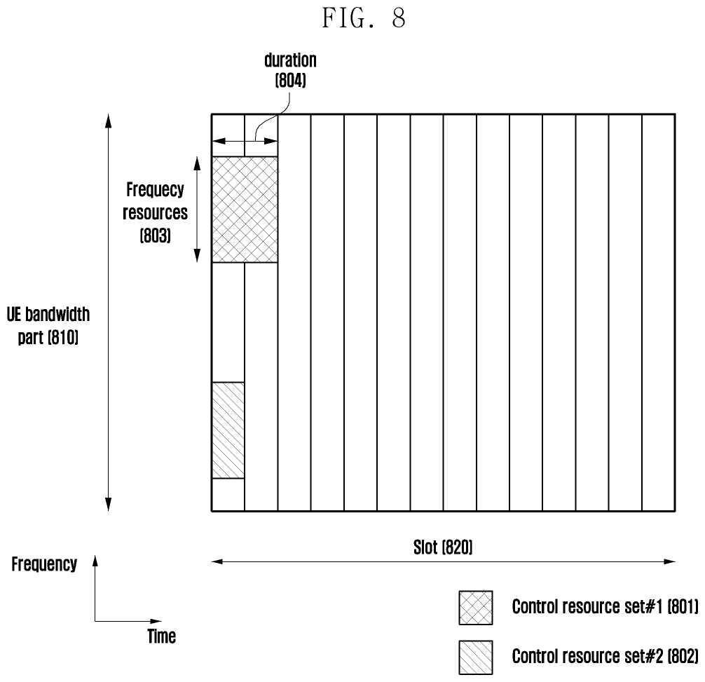

FIG. 8 illustrates an example of a configuration of a control resource set of a downlink control channel in a 5G communication system according to an embodiment of the disclosure. That is, FIG. 8 illustrates an example of a control resource set (CORESET) in which a downlink control channel is transmitted in the 5G wireless communication system.

Referring to FIG. 8, a terminal bandwidth part (UE bandwidth part) 810 is configured in the frequency domain, and two control resource sets, i.e., control resource set #1 801 and control resource set #2 802, are configured in one slot 820 in the time domain. The control resource sets 801 and 802 may be configured in a particular frequency resource 803 in the terminal bandwidth part 810 in the frequency domain, and one or multiple OFDM symbols may be configured in the time domain. The OFDM symbols may be defined as a control resource set duration 804. Referring to the illustrated example, control resource set #1 801 is configured as a 2-symbol control resource set length, and control resource set #2 is configured as a 1-symbol control resource set length.

The above-described each control resource set may be configured for the terminal by the base station via higher-layer signaling, for example, at least one of system information, a master information block (MIB), and RRC signaling. Configuring the terminal with the control resource set refers to providing the terminal with information such as a control resource set identity, the frequency position of the control resource set, and the symbol length of the control resource set. For example, a higher-layer signaling information element or control resource set configuration information for configuring a control resource set may include pieces of information of a ControlResourceSet information element in Table 10 below.

TABLE 10
ControlResourceSet ::= SEQUENCE {
controlResourceSetId,
frequencyDomainResources BIT STRING (SIZE (45)),
duration INTEGER (1..maxCoReSetDuration),
cce-REG-MappingType CHOICE {
interleaved SEQUENCE {
reg-BundleSize ENUMERATED {n2, n3, n6},
interleaverSize ENUMERATED {n2, n3, n6},
shiftIndex INTEGER(0..maxNrofPhysicalResourceBlocks-1)
OPTIONAL -- Need S
},
nonInterleaved NULL
},
precoderGranularity ENUMERATED {sameAsREG-bundle,
allContiguousRBs},
tci-StatesPDCCH-ToAddList SEQUENCE(SIZE (1..maxNrofTCI-
StatesPDCCH)) OF TCI-StateId OPTIONAL, -- Cond NotSIB1-
initialBWP
tci-StatesPDCCH-ToReleaseList SEQUENCE(SIZE (1..maxNrofTCI-
StatesPDCCH)) OF TCI-StateId OPTIONAL, -- Cond NotSIB1-
initialBWP
tci-PresentInDCI ENUMERATED {enabled} OPTIONAL, -- Need S
pdcch-DMRS-ScramblingID INTEGER (0..65535) OPTIONAL, -- Need
S
}

Here, “controlResourceSetId” indicates a control resource set identity, “frequencyDomainResources” indicates a frequency domain resource, “duration” indicates time duration of a control resource set, i.e., a time domain resource, “‘cce-REG-MappingType” indicates a CCE-to-REG mapping scheme, “reg-BundleSize” indicates a REG bundle size, “interleaverSize” indicates an interleaver size, and “shiftIndex” indicates an interleaver shift.

In addition, tci-StatesPDCCH corresponds to configuration information of transmission configuration indication (TCI) states, and may include one or multiple channel state information reference signal (CSI-RS) indices or SS/PBCH block indices which are in a quasi-co-located (QCL) relationship with DMRSs transmitted in the corresponding control resource set.

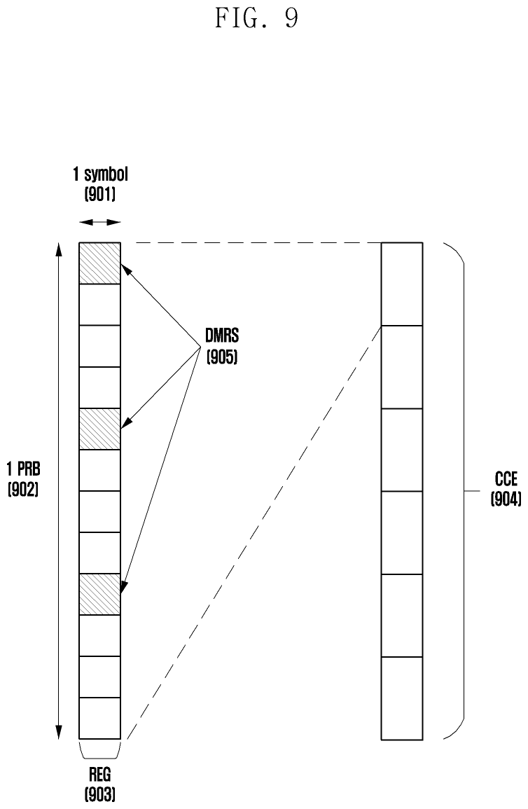

FIG. 9 illustrates a structure of a downlink control channel in a 5G communication system according to an embodiment of the disclosure. That is, FIG. 9 illustrates an example of a base unit of a time and frequency resource constituting a downlink control channel which can be used in the 5G wireless communication system.

Referring to FIG. 9, a basic unit of time and frequency resources constituting a control channel may be a resource element group (REG) 903, wherein the REG 903 may be defined as one OFDM symbol 901 in the time domain and may be defined as one PRB 902, i.e., 12 subcarriers, in the frequency domain. A base station may configure a downlink control channel allocation unit by concatenating one or more REGs 903.

If a basic unit for allocating a downlink control channel is a control channel element (CCE) 904 in the 5G system, one CCE 904 may include multiple REGs 903. In the REG 903 as an example, the REG 903 may include 12 REs, and if one CCE 904 includes six REGs 903, one CCE 904 may include 72 REs. An area where downlink control resource set is configured may include multiple CCEs 904, and a particular downlink control channel may be mapped to one or multiple CCEs 904 according to an aggregation level (AL) in the control resource set. The CCEs 904 in the control resource set are distinguished by numbers, wherein the numbers for the CCEs 904 may be assigned according to a logical mapping scheme.

A basic unit a downlink control channel, i.e., the REG 903, may include both an area of REs, to which DCI is mapped, and an area to which a DMRS 905 used for DCI demodulation is mapped. At least one (three in the illustrated example) DMRS 905 may be transmitted in the one REG 903. The numbers of CCEs required to transmit a downlink control channel may be 1, 2, 4, 8, and 16 according to the AL, and different numbers of CCEs may be used to implement link adaptation of the downlink control channel. If AL=L, one downlink control channel may be transmitted through L CCEs. A terminal is to detect a signal from a control resource set without knowing information on a downlink control channel, and thus, a search space representing a set of CCEs may be defined for such blind-decoding. A search space is a set of control channel candidates including CCEs for which the terminal is attempt decoding at a given AL, there are multiple ALs, each of which makes one group with 1, 2, 4, 8, and 16 CCEs, and thus, the terminal may have multiple search spaces. A search space set may be defined as a set of search spaces at all configured ALs.

### Search Space

The search spaces for the PDCCH may be classified into a common search space (CSS) and a terminal (UE)-specific search space (USS). Terminals in a predetermined group or all terminals may investigate a common search space to receive cell-common control information such as dynamic scheduling of system information or a paging message. For example, PDSCH scheduling allocation information for transmission of an SIB including information on a service provider of a cell may be detected by investigating a common search space. The common search space may be defined as a set of CCEs promised in advance so that terminals in a predetermined group or all terminals can receive the PDCCH. Scheduling allocation information of the UE-specific PDSCH or PUSCH may be detected by investigating a UE-specific search space. The UE-specific search space may be defined in a UE-specific manner according to a terminal identity and a function of various system parameters.

In the 5G system, parameters for the PDCCH search space may be configured for the terminal by the base station through higher-layer signaling (for example, SIB, MIB, or RRC signaling). For example, the base station may configure, for the terminal, the number of PDCCH candidates at each aggregation level L, a monitoring period of the search space, a monitoring occasion in units of symbols within the slot for the search space, a search space type (a common search space or a UE-specific search space), a combination of a DCI format and an RNTI to be monitored in the corresponding search space, and a control resource set index for monitoring the search space. For example, a higher-layer signaling information element for configuring parameters for the PDCCH search space may include the SearchSpace information element information as shown in Table 11 below.

```
TABLE 11
SearchSpace ::= SEQUENCE {
  searchSpaceId,
  controlResourceSetId ControlResourceSetId OPTIONAL, -- Cond
SetupOnly
  monitoringSlotPeriodicityAndOffset CHOICE {
sl1 NULL,
sl2 INTEGER (0..1),
...
  } OPTIONAL, -- Cond Setup
  duration INTEGER (2..2559) OPTIONAL, -- Need R
  monitoringSymbolsWithinSlot BIT STRING (SIZE (14))
OPTIONAL, -- Cond Setup
  nrofCandidates SEQUENCE {
    aggregationLevel1 ENUMERATED {n0, n1, n2, n3, n4, n5,
n6, n8},
    aggregationLevel2 ENUMERATED {n0, n1, n2, n3, n4, n5,
n6, n8},
    aggregationLevel4 ENUMERATED {n0, n1, n2, n3, n4, n5,
n6, n8},
    aggregationLevel8 ENUMERATED {n0, n1, n2, n3, n4, n5,
n6, n8},
    aggregationLevel16 ENUMERATED {n0, n1, n2, n3, n4, n5,
n6, n8}
  } OPTIONAL, -- Cond Setup
  searchSpaceType CHOICE {
    common SEQUENCE {
      dci-Format0-0-AndFormat1-0 SEQUENCE {
...
    },
    ue-Specific SEQUENCE {
dci-Formats ENUMERATED {formats0-0-And-1-0, formats0-1-And-1-
1},
...
    }
  } OPTIONAL -- Cond Setup2
}
```

Here, “searchSpaceId” indicates a search space identifier, “controlResourceSetId” indicates a control resource set identifier, “monitoringSlotPeriodicityAndOffset” indicates monitoring slot level periodicity, “duration” indicates the length of time duration to be monitored, “monitoringSymbolsWithinSlot” indicates symbols for PDCCH monitoring within a slot, “nrofCandidates” indicates the number of PDCCH candidates at each aggregation level, “searchSpaceType” indicates a search space type, “common” includes parameters for a common search space, and “ue-Specific” include parameters for a UE-specific search space.

The base station may configure one or multiple search space sets for the terminal according to the configuration information. According to an embodiment, the base station may configure search space set 1 and search space 2 for the terminal, and may configure for the terminal so that DCI format A scrambled by an X-RNTI in search space set 1 is monored in the common search space, DCI format B scrambled by a Y-RNTI in search space set 2 is monitored in the UE-specific search space.

According to the configuration information, there may be one or multiple search space sets in the common search space or the UE-specific search space. For example, search space set #1 and search space set #2 may be configured as common search spaces, and search space set #3 and search space set #4 may be configured as UE-specific search spaces.

In the common search space, monitoring may be performed for, but not limited to, the following combinations of DCI formats and RNTIs.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, monitoring may be performed for, but not limited to, the following combinations of DCI formats and RNTIs.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The above RNTIs may comply with the following definition and purpose.

Cell RNTI (C-RNTI): used for UE-specific PDSCH scheduling

Temporary Cell RNTI (TC-RNTI): used for UE-specific PDSCH scheduling

Configured Scheduling RNTI (CS-RNTI): used for semi-statically configured UE-specific PDSCH scheduling

Random Access RNTI (RA-RNTI): used for scheduling PDSCH at random access stage

Paging RNTI (P-RNTI): used for scheduling PDSCH through which paging is transmitted

System Information RNTI (SI-RNTI): used for scheduling PDSCH through which system information is transmitted

Interruption RNTI (INT-RNT): used for indicating whether puncturing is performed for PDSCH

Transmission power control for PUSCH (TPC-PUSCH-RNTI): used for indicating PUSCH power control command

Transmission power control for PUCCH RNTI (TPC-PUCCH-RNTI): used for indicating PUCCH power control command

Transmission power control for SRS RNTI (TPC-SRS-RNTI): used for indicating SRS power control command

The above DCI formats may comply with the following definition.

TABLE 12

| DCI | |
|---|---|
| format | Usage |
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the |
| | slot format |
| 2_1 | Notifying a group of UEs of the |
| | PRB(s) and OFDM symbol(s) |
| | where UE may assume no trans- |
| | mission is intended for the UE |
| 2_2 | Transmission of TPC commands |
| | for PUCCH and PUSCH |
| 2_3 | Transmission of a group of TPC |
| | commands for SRS transmissions |
| | by one or more UEs |

In the 5G communication system such as NR, a physical channel is distinguished from a physical signal as follows. For example, an uplink/downlink physical channel refers to a set of REs transferring information transmitted through a higher layer, and representatively, may include a PDCCH, a PUCCH, a PDSCH, a PUSCH, etc. An uplink/downlink physical signal refers to a signal which does not transfer information transmitted through a higher layer and is used in a physical layer, and representatively may include a DM-RS, a CSI-RS, SRS, etc.

In the disclosure, the physical channel and the physical signal are not distinguished from each other and may be described as a signal. For example, when it is described that a base station transmits a downlink signal, it may mean that the base station transmits at least one of a downlink physical channel and a downlink physical signal including a PDCCH, a PDSCH, a DM-RS, CSI-RS, etc. In other words, the term “signal” in the disclosure may be used as a term including both the channel and the signal above, and if necessary, the meanings thereof may be distinguished from each other according to the context.

### Slot Format Indicator (SFI)

In the 5G communication system, a downlink signal transmission interval and an uplink signal transmission interval may dynamically change. To this end, the base station may configure for the terminal whether each of OFDM symbols constituting one slot is a downlink symbol, an uplink symbol, or a flexible symbol through a slot format indicator (SFI). Here, the flexible symbol may be neither a downlink symbol nor an uplink symbol, or may refer to a symbol that can be changed to a downlink or uplink symbol by terminal-specific control information or scheduling information. In this case, the flexible symbol may include a gap guard required in a process of switching from the downlink to the uplink.

The terminal having received the slot format indicator may perform an operation of downlink reception from the base station in a symbol indicated as a downlink symbol, and perform an operation of uplink signal transmission to the base station in a symbol indicated as an uplink symbol. The base station may at least perform a PDCCH monitoring operation in a symbol indicated as a flexible symbol, and the terminal may perform an operation of downlink signal reception from the base station in the flexible symbol (for example, at the time of receiving DCI format 1_0 or 1_1), and perform an operation of uplink signal transmission to the base station in the flexible symbol (for example, at the time of receive DCI format 0_0 or 0_1) through another indicator, for example, DCI.

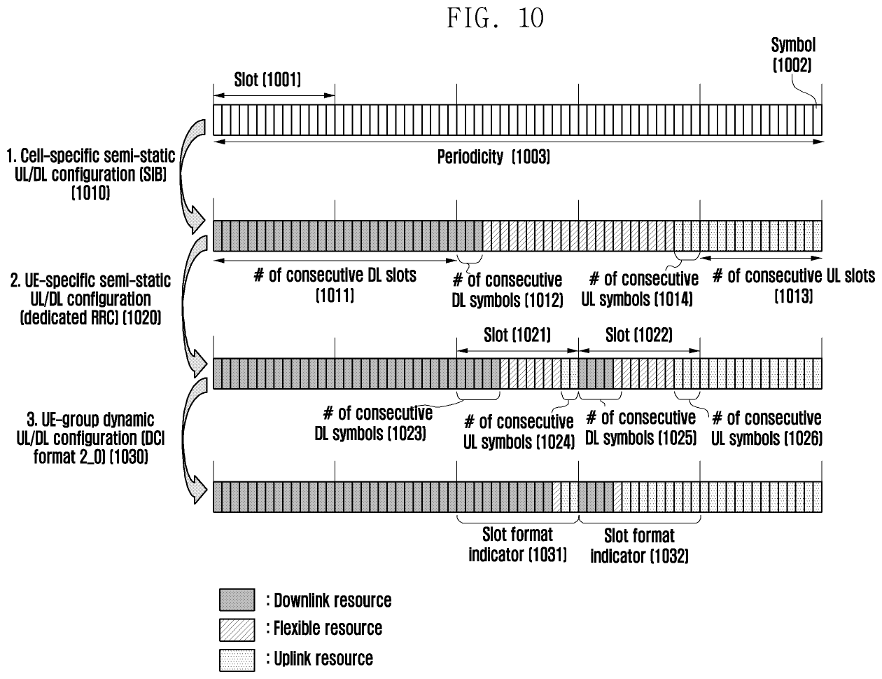

FIG. 10 illustrates an example of an uplink-downlink configuration (UL/DL configuration) in a 5G system, and illustrates three stages of the uplink-downlink configuration of a symbol/slot according to an embodiment of the disclosure.

Referring to FIG. 10, in the first stage, cell-specific configuration information 1010 for a semi-static uplink-downlink configuration, for example, system information such as an SIB, is used for the uplink-downlink configuration of a symbol 1002 slot 1001. Specifically, the cell-specific uplink-downlink configuration information 1010 in the system information may include information indicating uplink-downlink pattern information and reference subcarrier spacing. The uplink-downlink pattern information may indicate transmission periodicity 1003 of each pattern, the number of consecutive downlink slots from a starting point of each pattern (the number of consecutive full DL slots at the beginning of each DL-UL pattern) 1011, the number of consecutive downlink symbols from a starting point of the next slot (the number of consecutive DL symbols in the beginning of the slot following the last full DL slot) 1012, the number of consecutive uplink slots from the end of each pattern (the number of consecutive full UL slots at the end of each DL-UL pattern) 1013, and the number of symbols of the immediately preceding slot (the number of consecutive UL symbols in the end of the slot preceding the first full UL slot) 1014. In this case, the terminal may determine a slot/symbol that is not indicated as the uplink or the downlink as a flexible slot/symbol.

In the second stage, terminal-specific (UE-specific) configuration information 1020 transferred through higher-layer signaling (i.e., RRC signaling) dedicated to the terminal indicates symbols to be used for a downlink or uplink configuration in a flexible slot or slots 1021 and 1022 including a flexible symbol. For example, the UE-specific uplink-downlink configuration information 1020 may include a slot index indicating slots 1021 and 1022 including a flexible symbol, the number of consecutive downlink symbols from the beginning of each slot (the number of consecutive DL symbols in the beginning of the slot) 1023 and 1025, the number of consecutive uplink symbols from the end of each slot (the number of consecutive UL symbols in the end of the slot) 1024 and 1026, information indicating the entire downlink of each slot, or information indicating the entire uplink of each slot. In this case, the symbol/slot configured as the uplink or the downlink according to the cell-specific configuration information 1010 in the first stage cannot be changed to the downlink or the uplink through the UE-specific higher-layer signaling 1020.

In the last stage, in order to dynamically change a downlink signal transmission period and an uplink signal transmission period, downlink control information of a downlink control channel includes a slot format indicator 1030 indicating whether each symbol in each slot among multiple slots starting from a slot in which a terminal has detected the downlink control information corresponds to a downlink symbol, an uplink symbol, or a flexible symbol. In this case, for the symbol/slot configured as the uplink or the downlink in the first and the second stage, the slot format indicator cannot indicate whether the symbol/slot corresponds to the downlink or the uplink. A slot format of each slot 1031 or 1032 including at least one symbol that is not configured as the uplink or the downlink in the first and the second stage may be indicated by the corresponding downlink control information.

The slot format indicator may indicate an uplink-downlink configuration for 14 symbols in one slot as shown in Table 13 below. The slot format indicators may be dynamically transmitted to multiple terminals through a terminal group (or cell) common control channel. In other words, downlink control information including a slot format indicator may be transmitted through a PDCCH CRC-scrambled with an identifier different from a terminal-specific cell-RNTI (C-RNTI), for example, an SF-RNTI. The downlink control information may include a slot format indicator for one or more slots, i.e., N slots. Here, the value of N is an integer larger than 0 or a value configured for the terminal by the base station through higher-layer signaling, among pre-defined available values such as 1, 2, 5, 10, and 20. The size of the slot format indicator may be configured for the terminal by the base station through the higher-layer signaling. Table 13 shows the details of the SFI.

TABLE 13

| | Symbol number (or index) in one slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |

. . .

| | | | | | | | | | | | | | | |
|---|---|---|---|---|---|---|---|---|---|---|---|---|---|---|
| 9 | F | F | F | F | F | F | F | F | F | F | F | F | U | U |

. . .

| | | | | | | | | | | | | | | |
|---|---|---|---|---|---|---|---|---|---|---|---|---|---|---|
| 19 | D | F | F | F | F | F | F | F | F | F | F | F | F | U |

. . .

| | | | | | | | | | | | | | | |
|---|---|---|---|---|---|---|---|---|---|---|---|---|---|---|
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on |
| | tdd-UL-DL-ConfigurationCommon, or |
| | tdd-UL-DL-ConfigurationDedicated and, |
| | if any, on detected DCI formats |

In Table 13, D indicates a downlink symbol, U indicates an uplink symbol, and F indicates a flexible symbol. According to Table 13, a total number of slot formats that are supportable for one slot is 256. In the NR system, the maximum size of an information bit which can be used for the slot format indication is 128 bits, and may be configured for the terminal by the base station through the higher-layer signaling, for example, “dci-PayloadSize”.

In this case, a cell operating in the unlicensed band may configure and indicate an additional slot format by introducing one or more slot additional slot formats or amending one or more existing slot formats, as shown in Table 14. Table 14 shows an example of additional slot formats in which one slot includes only an uplink symbol and a flexible symbol (F).

TABLE 14

| | Symbol number (or index) in one slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 56 | F | U | U | U | U | U | U | U | U | U | U | U | U | U |
| 57 | F | F | U | U | U | U | U | U | U | U | U | U | U | U |
| 58 | U | U | U | U | U | U | U | U | U | U | U | U | U | F |
| 59 | U | U | U | U | U | U | U | U | U | U | U | U | F | F |
| . . . | | | | | | | | | | | | | | |

In an embodiment, downlink control information used for the slot format indication may indicate slot formats for multiple service cells, and a slot format for each serving cell may be distinguished by a serving cell ID. In addition, a slot format combination for one or more slots for each serving cell may be indicated by the downlink control information. For example, when the size of one slot format indicator index field in the downlink control information is 3 bits and indicates a slot format for one serving cell, the 3-bit slot format indicator index field may indicate one of a total of eight slot formats (or a slot format combination), and the base station may indicate the slot format indicator index field through terminal group common downlink control information (DCI).

In an embodiment, at least one slot format indicator index included in the downlink control information may include a slot format combination indicator for multiple slots. For example, Table 15 shows a 3-bit slot format combination indictor configured by the slot formats in Table 13 and Table 14. Among the values of the slot format combination indicators, each value of {0, 1, 2, 3, 4} indicates a slot format for one slot. The other three values {5, 6, 7} indicate slot formats for four slots, and the terminal may sequentially apply the indicated slot formats to four slots starting from a slot in which downlink control information including the slot format combination indicator has been detected.

TABLE 15

| Slot format | Slot |
|---|---|
| combination ID | Formats |
| 0 | 0 |
| 1 | 1 |
| 2 | 2 |
| 3 | 19 |
| 4 | 9 |
| 5 | 0 0 0 0 |
| 6 | 1 1 1 1 |
| 7 | 2 2 2 2 |

### Unlicensed Band

In a case of a system performing communication in an unlicensed band, before transmitting a signal, a communication device (a base station or a terminal) to transmit the signal through the unlicensed band may perform a channel access procedure, listen-before-talk (LBT), or channel sensing for the unlicensed band through which the communication device desires to perform communication, and may access the unlicensed band and transmit the signal if it is determined according to the channel access procedure that the unlicensed band is in an idle state. If it is determined according to the performed channel access procedure that the unlicensed band is not in an idle state, the communication device may not transmit the signal. Here, the channel access procedure corresponds to a procedure in which a base station or a terminal occupies a channel for a deterministic time or a predetermined time, measures the strength of a signal received through a channel through which the base station or the terminal desires to transmit the signal, and compares the measured strength of the signal with a pre-defined threshold or a threshold X_{Thresh} obtained by a function for determining a value by at least one parameter of a channel bandwidth, a signal bandwidth in which a signal to be transmitted is transmitted, and/or the strength of transmission power.

The strength of the received signal, which is measured through channel sensing for the unlicensed band, is less than X_{Thresh}, the base station and the terminal may determine that the channel is in an idle state or determine that the channel can be used (or occupied), and may occupy and use the channel. If the sensing result is greater than X_{Thresh}, the base station and the terminal may determine that the channel is in a busy state or determine that the channel cannot be used (or occupied), and may not use the channel. In this case, the base station and the terminal may continuously perform sensing until it is determined that the channel is in an idle state. In other words, the channel access procedure in the unlicensed band may mean a procedure of assessing availability of performing transmission in the channel according to the sensing. A basic unit of the sensing may be Tₛₗ=9 μs duration in a sensing slot. In this case, in the sensing slot duration, if power detected in at least 4 μs is less than X_{Thresh}, it may be considered that the sensing slot duration is idle or is not being used. In the sensing slot duration, if power detected in at least 4 μs is equal to or greater than X_{Thresh}, it may be considered that the sensing slot duration is busy or is being used by other devices.

In the channel access procedure in the unlicensed procedure, the communication device may be divided into frame-based equipment (FBE) and load-based equipment (LBE) according to whether a time point at which the communication device initiates the channel access procedure is fixed (or semi-static) or variable (or dynamic). In addition to the channel access procedure initiation time point, the communication device may be determined as an FBE or an LBE according to whether a transmission/reception structure of the communication device has a single period or not. Here, when the channel access procedure initiation time point is fixed, it may mean that the channel access procedure of the communication device can be periodically initiated according to the pre-defined declare or configured period. In another example, when the channel access procedure initiation time point is fixed, it may mean that the transmission/reception structure of the communication device has a single period. When the channel access procedure initiation time point is variable, it may mean that the communication device can initiate the channel access procedure at any time the communication device desires to transmit a signal through the unlicensed band. In another example, when the channel access procedure initiation time point is variable, it may mean that the transmission/reception structure of the communication device may be determined as necessary rather than having a single period. In the disclosure below, the channel access procedure and the channel sensing may be interchangeably used, or the channel access procedure of the base station or the terminal may be identical to a channel sensing operation.

In the disclosure below, a downlink (DL) transmission burst may be defined as follows. The downlink transmission burst may mean a set of downlink transmissions without a gap larger than 16 μs between downlink transmissions of a base station. When the gap between the downlink transmissions is larger than 16 μs, the downlink transmissions may mean downlink transmission bursts which are separated from each other. Similarly, an uplink (UL) transmission burst may be defined as follows. The uplink transmission burst may mean a set of uplink transmissions without a gap larger than 16 μs between uplink transmissions of a terminal. When the gap between the uplink transmissions is larger than 16 μs, the uplink transmissions may mean downlink transmission bursts which are separated from each other.

### Channel Access Procedure for Semi-Static Channel Occupancy

Hereinafter, a channel access procedure in a case where a fixed or semi-static channel access procedure initiation time point is configured is described.

In the 5G system in which communication is performed in the unlicensed band, when it can be guaranteed that there is no another system which shares and uses an unlicensed band channel for a long time by the regulation or by a method at the same level of the regulation, the following semi-static channel access procedure or channel sensing can be performed.

A base station which desires to use a semi-static channel access procedure may provide a terminal with configuration information indicating that the type of a channel access procedure of the base station is a semi-static channel access procedure and/or configuration information relating to semi-static channel access, through higher-layer signaling (for example, SIB1 and/or RRC signaling), wherein the terminal may identify that the type of the channel access procedure of the base station is the semi-static channel access procedure. Here, as an example of the configuration information relating to semi-static channel access, there may be a period (Tₓ) at which the base station can initiate channel occupancy. For example, the period may have a value of 1 ms, 2 ms, 2.5 ms, 4 ms, 5 ms, or 10 ms. In a case of using the semi-static channel access procedure, the base station may initiate periodic channel occupancy at each Tₓ among two consecutive frames, i.e., at each x·Tₓ staring from a frame having an even-numbered index, and occupy the channel for maximum T_{y}=0.95 Tₓ. Here, x may satisfy

$$x ∈ \{ 0 , 1 , … , \frac{20}{{T}_{x}} - 1 \} .$$

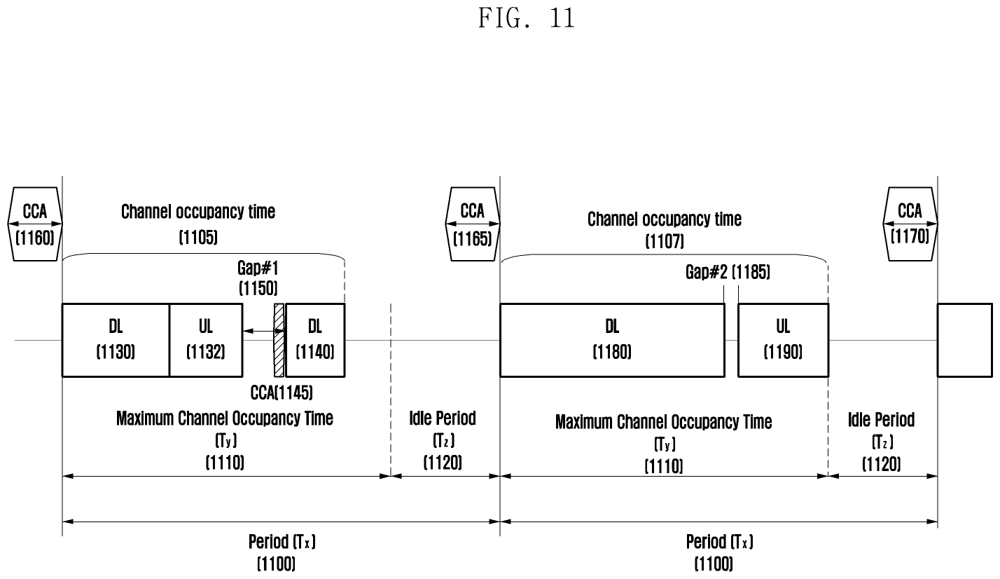

FIG. 11 illustrates an example of a channel access procedure for semi-static channel occupancy in a wireless communication system according to an embodiment of the disclosure.

Referring to FIG. 11, it shows a periodic channel occupancy period (Tₓ) 1100, a channel occupancy time (COT) 1105 or 1107, a maximum channel occupancy time (T_{y}) 1110, an idle period (T) 1120, and clear channel assessment (CCA) duration 1160, 1165, or 1170 in a base station and a terminal for performing a semi-static channel access procedure.

The base station and the terminal using the semi-static channel access procedure may perform channel sensing in the channel assessment duration 1160 or 1165 that is immediately before using or occupying (e.g., downlink transmission 1130 or downlink transmission 1180) a channel to assess whether the channel can be used (or occupied). In this case, the sensing is to be performed during at least one sensing slot duration, and an example of the sensing slot duration (Tₛₗ) is 9 μs.

As an example of the sensing method, the magnitude or the strength of received power, which is measured or detected from the sensing slot duration, may be compared with a pre-defined, pre-configured, or pre-calculated threshold X_{Thresh}. For example, the result of the sensing in the base station and the terminal which have performed sensing in the channel assessment duration 1160 has a value smaller than X_{Thresh}, the base station and the terminal may determine that the channel is in an idle state or may determine that the channel can be used (or occupied), may occupy the channel, and may use the channel until the maximum channel occupancy time 1110. If the result of the sensing has a value equal to or larger than X_{Thresh}, the base station and the terminal may determine that the channel is in a busy state or determine that the channel cannot be used (or occupied), and may not use the channel until the next channel occupancy initiable time (i.e., downlink transmission 1180) or the channel sensing time 1165 in the next channel assessment duration 1165.

When the base station has performed the semi-channel access procure and initiated the channel occupancy, the base station and the terminal may perform communication as follows.
The base station should perform downlink transmission at the starting time point of a channel occupancy time immediately after the sensing slot duration is sensed as in an idle state. If the sensing slot duration is sensed as in a busy state, the base station should not perform any transmission during the current channel occupancy time.
If a gap 1150 between the downlink transmission 1140 to be performed within a channel occupancy time 1105 and the previous downlink transmission 1130 and uplink transmission 1132 is greater than 16 μs, the base station may perform sensing for at least one sensing slot duration 1145 and can or may not perform the downlink transmission 1140 according to the result of the sensing.
If the gap 1150 between the downlink transmission 1140 to be performed within the channel occupancy time 1105 and the previous uplink transmission 1132 of the terminal corresponds to the maximum 16 μs (or is equal to or less than 16 μs), the base station may perform the downlink transmission 1140 without channel sensing (without sensing slot duration 1145).
If the terminal performs uplink transmission 1190 within a channel occupancy time 1107 of the base station and a gap 1185 between uplink transmission 1190 and downlink transmission 1180 corresponds to the maximum 16 μs (or is equal to or less than 16 μs), the terminal may perform the uplink transmission 1190 without channel sensing.
If the terminal performs uplink transmission within the channel occupancy time 1107 of the base station and the gap 1185 between uplink transmission 1190 and downlink transmission 1180 is greater than 16 μs, the terminal may perform channel sensing in at least one sensing slot duration within 25 μs duration immediately before the uplink transmission 1190, and may or may not perform the uplink transmission 1190 according to the result of the sensing.
The base station and the terminal should not perform any transmission in a set of consecutive symbols of at least T_{z}=max((0.05 Tₓ, 100 μs) duration before the next channel occupancy time starts.

### Channel Access Procedure for Dynamic Channel Occupancy

Hereinafter, a channel access procedure in a case where a channel access procedure initiation time point of a communication device is variable or dynamic is described. In the 5G system in which communication is performed in the unlicensed band, when the semi-static channel access procedure is not used or the dynamic channel access procedure is performed, the terminal may perform the following types of channel access procedures or channel sensing.

Type-1 Downlink Channel Access Procedure

According to the type-1 downlink channel access procedure, before downlink transmission, the base station may perform channel sensing during a predetermine time or a time corresponding to the number of sensing slots corresponding to the predetermined time, and may perform the downlink transmission when the channel is in an idle state. The type-1 downlink channel access procedure is described in detail below.

In the type-1 downlink channel access procedure, parameters for the type-1 downlink channel access procedure may be determined according to a quality of service (QoS) class identifier (QCI) or a 5G QoS identifier (5QI) of a signal to be transmitted through a channel in the unlicensed band. Table 16 below shows an example of relationships between a channel access priority class and the QCI or the 5QI. For example, each of QCI 1, 2, and 4 may mean a QCI value for a service such as conversational voice, conversational video (live streaming), and non-conversational video (buffered streaming)).

If a signal for a service not matching the QCI or the 5QI in Table 16 is to be transmitted in the unlicensed band, a transmission device may select a service and a QCI that is closest to the QCI or the 5QI in Table 16, and select the type of the channel access priority therefor. In addition, when a signal to be transmitted through a channel in the licensed band has a plurality of different QCIs or 5QIs, a channel access priority class may be selected with reference to the channel access priority class having the lowest QCI or 5QI.

TABLE 16

| Channel | | | | | | |
|---|---|---|---|---|---|---|
| Access | | | | | | Allowed |
| Priority | | | | | | CWₚ |
| class (p) | QCI or 5QI | mₚ | CW_{min,p} | CW_{max,p} | T_{mcot,p} | sizes |
| 1 | 1, 3, 5, 65, 66, | 1 | 3 | 7 | 2 ms | {3, 7} |
| | 69, 70, 79, 80, | | | | | |
| | 82, 83, 84, 85 | | | | | |
| 2 | 2, 7, 71 | 1 | 7 | 15 | 3 ms | {7, 15} |
| 3 | 4, 6, 8, 9, 72, | 3 | 15 | 63 | 8 or | {15, 31, |
| | 73, 74, 76 | | | | 10 ms | 63} |
| 4 | — | 7 | 15 | 1023 | 8 or | {15, 31, |
| | | | | | 10 ms | 63, 127, |
| | | | | | | 255, 511, |
| | | | | | | 1023} |

When a channel access priority class value (P) is determined according to the QCI or the 5QI of a signal to be transmitted through a channel in the unlicensed band, a channel access procedure may be performed by using channel access procedure parameters each corresponding to the determined channel access priority class value. For example, as shown in Table 16, a channel access procedure may be performed by using channel access procedure parameters each corresponding to the channel access priority class value (P), wherein the channel access procedure parameters include mₚ which determines the length of defer duration T_{d}, a set CWₚ of contention window (CW) values or sizes, and the minimum value and maximum value CW_{min,p} and CW_{max,p}) of the contention window. In this case, after the channel occupancy, an available maximum channel occupancy time (T_{mcot,p}) may also be determined according to the channel access priority class value (P).

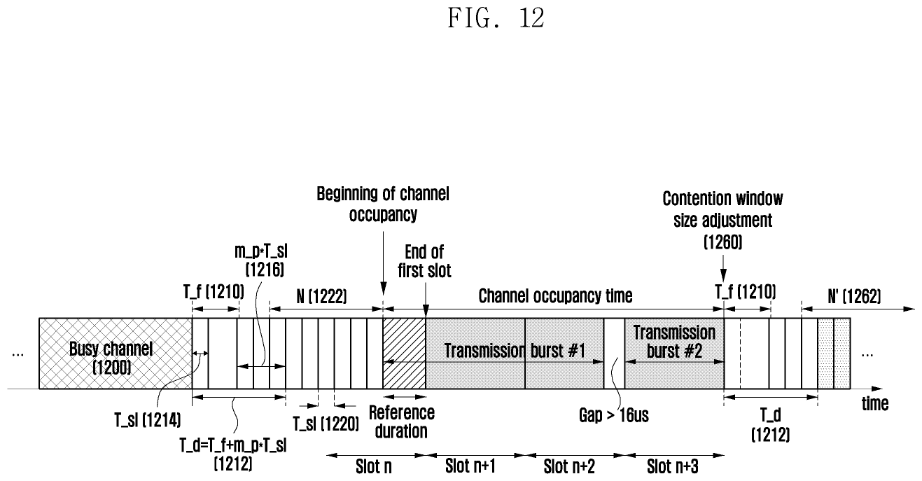

FIG. 12 illustrates an example of a channel access procedure for dynamic channel occupancy in a wireless communication system according to an embodiment of the disclosure. That is, an example of a type-1 downlink channel access procedure of a base station is illustrated.

Referring to FIG. 12, a base station which desires to transmit a downlink signal in the unlicensed band may perform a channel access procedure within at least T_{d} 1212 of defer duration. Here, defer duration T_{d} 1212 may be subsequentially configured by T_{f} 1210 and mₚ×Tₛₗ 1216. Here, T_{f} 1210 may refer to 16 μs, and Tₛₗ 1214 and 1220 may refer to the length of a sensing slot. In this case, T_{f} 1210 may include one sensing slot 1214, wherein the sensing slot 1214 may be located at a starting point of T_{f} 1210. When the base station performs a channel access procedure with channel access priority class 3 (p=3) in Table 16, defer duration T_{d} 1212 required for performing the channel access procedure may be determined as T_{f}+mₚ×Tₛₗ. Here, mₚ may satisfy mₚ=3. When the first Tₛₗ 1214 of T_{f} 1210 is in an idle state, the base station may not perform the channel access procedure in the remaining time (T_{f}−Tₛₗ) after the first Tₛₗ 1214 of T_{f} 1210. In this case, even though the base station has performed the channel access procedure in the remaining time (T_{f}−Tₛₗ), the result of the channel access procedure may not be used. That is, T_{f}−Tₛₗ may mean a time of deferring the channel access procedure regardless of the performance of the channel access procedure by the base station.

When it is determined that the unlicensed band is in an idle state in T_{d} 1212, the base station may start channel occupancy after N sensing slots 1222. Here, N indicates an integer value randomly selected by using 0 and a channel access procedure initiation time point or a value of the previous contention window (CWₚ). That is, N may be a value determined according to N=rand(0,CWₚ). A method for configuring a contention window will be described below in detail. For example, when the channel access priority class in Table 16 corresponds to p=3, the minimum contention window value and the maximum contention window value are 15 and 63, respectively, and a possible contention window corresponds to {15, 31, 63}. Therefore, the value of N may be randomly selected from a window of 0 to 15, 0 to 31, and 0 to 63 according to a contention window value. The base station may perform sensing in each sensing slot and may update N with N=N−1 when the strength of a received signal, which is measured in the sensing slot, is less than a threshold (X_{Thresh}). When the strength of the received signal, which is measured in the sensing slot, is equal to or greater than a threshold (X_{Thresh}), the base station may perform channel sensing in defer duration (T_{d}) while maintaining the value of N without deduction. When N=0 is determined, the base station may perform downlink transmission. In this case, the base station may occupy and use the channel during T_{mcot,p} according to the channel access procedure class and Table 16.

In an embodiment, after the channel occupancy time, contention window size adjustment 1260 may be performed. After the contention window size adjustment 1260, defer duration T_{d} 1212 required for a channel access procedure may exist again. Defer duration T_{d} 1212 may include T_{f} 1210. The channel access procedure may resume after N′ 1262.

The type-1 downlink channel access procedure may be divided into the following stages. The base station may sense whether a channel is in an idle state in sensing slot duration of defer duration T_{d} 1212, and may perform downlink transmission when the counter N has a value of 0. In this case, the value of the counter N may be adjusted according to channel sensing performed in additional sensing slot durations according to the following stages.

Stage 1: N=Nᵢₙᵢₜ is configured and moving to stage 4 is performed. Here, Nᵢₙᵢₜ indicates a value randomly selected between 0 and CWₚ.

Stage 2: If N>0, the base station determines whether to reduce the counter N. If the base station determines to reduce the counter, N=N−1 is configured.

Stage 3: The base station performs channel sensing during additional sensing slot durations. If it is determined that the channel is in an idle state, moving to stage 4 is performed. If the channel is not in the idle state, moving to stage 5 is performed.

Stage 4: If N=0, downlink transmission is initiated, and if not N=0, moving to stage 2 is performed.

Stage 5: Channel sensing is performed until a sensing slot in a busy state in defer duration T_{d} is detected or until it is detected that a sensing slot in defer duration T_{d} is in an idle state.

Stage 6: If it is detected that all sensing slots in defer duration T_{d} are in the idle state, moving to stage 4 is performed. Otherwise, moving to stage 5 is performed.

A procedure of maintaining or adjusting a contention window (CWₚ) value of a base station is as follows. In this case, a contention window adjustment procedure is applied when the base station has performed downlink transmission including a PDSCH corresponding to at least channel access priority class p, and includes the following stages.

Stage 1: CWₚ=CW_{min,p} is configured for all channel access priority classes p.

Stage 2:
If HARQ-ACK feedback is available after the last CWₚ update, moving to stage 3 is performed.
In other cases, if downlink transmission of the base station after the type-1 channel access procedure does not include retransmission, or if the downlink transmission is performed in T_{w} immediately after reference duration of the first transmitted downlink (DL) transmission burst after the type-1 channel access procedure after the last CWₚ update, moving to stage 5 is performed.
Otherwise, moving to stage 4 is performed.

Stage 3: HARQ-ACK feedback on a PDSCH transmitted in a reference duration of the recent downlink transmission burst in which HARQ-ACK feedback on the PDSCH transmitted in the reference duration is available is used as follows.
Among the above HARQ-ACK feedback, if at least one of HARQ-ACK feedback on a PDSCH transmitted in units of transport blocks (TBs) corresponds to ACK, or among the above HARQ-ACK feedback, if at least 10% of HARQ-ACK feedback on a PDSCH transmitted in units of code block groups (CBGs) corresponds to ACK, moving to stage 1 is performed.
Otherwise, moving to stage 4 is performed.

Stage 4: For all channel access priority classes p, CWₚ is increased to the next larger value than a current value among available CWₚ values.
If the current value corresponds to CWₚ=CW_{max,p}, the next available larger CWₚ value is CW_{max,p}.
If CWₚ=CW_{max,p} is consecutively used K times in generating Nᵢₙᵢₜ, for the channel access priority class p, CWₚ may be initialized to CW_{min,p}. In this case, for each channel access priority class p, the base station may select K among {1, 2, . . . , 8}.

Stage 5: For all channel access priority classes p, CWₚ is maintained and moving to stage 2 is performed.

In the above description, T_{w} corresponds to max(T_{A}, T_{B}+1 ms). Here, T_{B}, which is uplink/downlink transmission burst duration from the start of the reference duration, is a value in a ms unit. In the 5G system in which communication is performed in the unlicensed band, if it cannot be guaranteed that there is no another system which shares and uses an unlicensed band channel for a long time by the regulation or by a method at the same level of the regulation, T_{A}=5 ms, and otherwise, T_{A}=10 ms.

In an embodiment, among the channel occupancy including PDSCH transmission of the base station, the reference duration may mean duration coming first in time among duration which corresponds to duration from the channel occupancy start to the last of the first slot and includes at least one unicast PDSCH transmitted through all time-frequency resource areas allocated to the PDSCH, and duration which corresponds to duration from the channel occupancy start to the end of the downlink transmission burst and includes at least one unicast PDSCH transmitted through all time-frequency resource areas allocated to the PDSCH. If a unicast PDSCH is included in the channel occupancy of the base station but a unicast PDSCH transmitted through all time-frequency resource areas allocated to the PDSCH is not included, the first transmission burst duration including the unicast PDSCH may be reference duration. Here, the channel occupancy may mean transmission performed by the base station after the channel access procedure.

Type-2A Downlink Channel Access Procedure

According to the type-2A downlink channel access procedure, the base station may perform channel sensing in at least T_{short_dl}=25 μs duration immediately before downlink transmission and perform downlink transmission when the channel is in an idle state. In this case, T_{short_dl} corresponds to the length of 25 μs and sequentially includes T_{f}=16 μs and at least one sensing slot (Tₛₗ=9 μs). Here, T_{f} includes one sensing slot (Tₛₗ=9 μs), and the start time point of the sensing slot may be identical to the start time point of T_{f}. That is, T_{f} may start with the sensing slot (Tₛₗ). When the base station performs downlink transmission in which a downlink data channel transmitted to a particular terminal is not included, the type-2A downlink channel access procedure may be performed.

Type-2B Downlink Channel Access Procedure

According to the type-2B downlink channel access procedure, the base station may perform channel sensing in at least T_{f}=16 μs duration immediately before downlink transmission and perform downlink transmission when the channel is in an idle state. Here, T_{f} includes one sensing slot (Tₛₗ=9 μs), and the sensing slot may be located in the last 9 μs of T_{f}. That is, T_{f} ends with the sensing slot (Tₛₗ). The type-2B downlink channel access procedure may be applied when a gap between the start of downlink transmission to be performed by the base station and the end of uplink transmission of the terminal is 16 μs or is equal to or greater than 16 μs.

Type-2C Downlink Channel Access Procedure

The type-2C downlink channel access procedure can be applied when a gap between the start of the downlink transmission of the base station and the end of the uplink transmission of the terminal is 16 μs or is equal to or greater than 16 μs, and the base station may perform the downlink transmission without an additional procedure or channel sensing. In this case, the maximum duration of the downlink transmission performed after performing the type-2C downlink channel access procedure may be 584 μs.

Unlike the type-1 downlink channel access procedure, in the type-2A, type-2B, and type-2C downlink channel access procedures, a time point or duration of channel sensing performed by the base station before the downlink transmission is deterministic. With reference to the deterministic feature above, the downlink channel access procedure may be additionally divided into the following types.
Type 1: This is a type of performing downlink transmission after the channel access procedure during a variable time, and corresponds to the type-1 downlink channel access procedure.
Type 2: This is a type of performing downlink transmission after the channel access procedure during a fixed time, and corresponds to the type-2A and the type-2B downlink channel access procedure.
Type 3: This is a type of performing downlink transmission without performing the channel access procedure, and corresponds to the type-2C downlink channel access procedure.

### Energy Detection Threshold Adjustment Procedure

The base station which performs the channel access procedure or channel sensing may configure an energy detection threshold or a sensing threshold X_{Thresh} as follows. In this case, X_{Thresh} is to be configured as a value equal to or smaller than X_{Thresh_max} indicating a maximum energy detection threshold or a sensing threshold and is in a dBm unit.

In the 5G system in which communication is performed in the unlicensed band, when it can be guaranteed that there is no another system which shares and uses an unlicensed band channel for a long time by the regulation or by a method at the same level of the regulation, X_{Thresh_max} satisfies X_{thresh_max}=min (Tₘₐₓ+10 dB, Xᵣ). Here, Xᵣ indicates the maximum detection threshold required by each local regulation and is in a dBm unit. If a maximum detection threshold required by the regulation is neither configured nor defined, Xᵣ may satisfy Xᵣ=Tₘₐₓ+10 dB.

In a case other than the above case, that is, in a case where, in the 5G system in which communication is performed in the unlicensed band, when it cannot be guaranteed that there is no another system which shares and uses an unlicensed band channel for a long time by the regulation or by a method at the same level of the regulation, the maximum energy detection threshold may be determined by Equation 1 below.

$$Equation 1 : ED threshold$$

$${X}_{Thresh \_ max} = max \{ \begin{matrix}- 72 + 10 log 10 ( BW MHz / 20 MHz ) dBm , \\ min \{ \begin{matrix}{T}_{max} , \\ {T}_{max} - {T}_{A} + ( {P}_{H} + 10 log 10 ( BW MHz / 20 MHz ) - {P}_{TX}\end{matrix} \}\end{matrix} \}$$

In the above Equation 1, when performing transmission including a PDSCH, T_{A} is 10 dBm, and when performing transmission including a discovery signal and channel, T_{A} is 5 dB. P_{H} is 23 dBm and, P_{TX}, which is the maximum output power of the base station, is in a dBm unit. The base station may calculate a threshold by using the maximum output power transmitted through a channel, regardless of downlink transmission through one channel or multiple channels. Here, Tₘₐₓ=10 log 10(3.16228·10⁻⁸ (mW/MHz)·BWMHz(MHz)), and a BW corresponding to a bandwidth of one channel is in a MHz unit.

According to an embodiment, a method for determining an energy detection threshold X_{Thresh} for channel access for uplink transmission by a terminal is as follows.

The base station may configure the maximum energy detection threshold for the terminal through higher-layer signaling, for example, “maxEnergyDetectionThreshold”. A terminal having been provided or configured with “maxEnergyDetectionThreshold” from the base station may configure X_{Thresh_max} as a value configured by the parameter. A terminal having not been provided or configured with “maxEnergyDetectionThreshold” from the base station may configure X_{Thresh_max} as follows. If the terminal has not been provided or configured with an energy detection threshold offset (for example, energyDetectionThresholdOffset provided through higher-layer signaling) from the base station, the terminal may configure X_{Thresh_max} as X′_{Thresh_max}. If the terminal has been provided or configured with the energy detection threshold offset from the base station, X′_{Thresh_max} may be configured as a value obtained by adjusting X′_{Thresh_max} by the energy detection threshold offset. Here, X′_{Thresh_max} may be determined as follows.

In the 5G system in which communication is performed in the unlicensed band, when it can be guaranteed that there is no another system which shares and uses an unlicensed band channel for a long time by the regulation or by a method at the same level of the regulation, the base station may provide the terminal with, for example, “absenceOfAnyOtherTechnology” through higher-layer signaling. The terminal having been provided or configured with “absenceOfAnyOtherTechnology” through higher-layer signaling may configure X′_{Thresh_max}=min{Tₘₐₓ+10 dB,Xₓ} Here, Xᵣ is the maximum energy detection threshold required by each local regulation and is in a dBm unit. If no maximum energy detection threshold required by the regulation is configured or defined, Xᵣ=Tₘₐₓ+10 dB. The terminal having not been provided or configured with “absenceOfAnyOtherTechnology” through higher-layer signaling may determine X′_{Thresh_max} according to Equation 1 above. In this case, T_{A}=10 dBm, P_{H}=23 dBm, and P_{TX} corresponds to P_{CMAX_H,c}.

### EMBODIMENT

An example of the maximum transmission output and power spectral density (PSD) limitations in the 5 GHz unlicensed band in the United States is shown as Table 17 below.

TABLE 17

| | UNII-1 | UNII-2A | UNII-2C | UNII-3 |
|---|---|---|---|---|
| Frequency | 5150-5250 | 5250-5350 | 5470-5725 | 5725-5850 |
| band | MHz | MHz | MHz | MHz |
| Maximum | AP: 30 dBm | AP/STA: | AP/STA: | AP/STA: 30 |
| output | STA: 24 dBm | min(24, 11 + 10 | min(24, 11 + 10 | dBm |
| power (Max | | logB) dBm | logB) dBm | |
| conducted | | | | |
| output | | | | |
| power) | | | | |
| Maximum | AP: | AP/STA: | AP/STA: | AP/STA: |
| PSD | 17 dBm/MHz | 11 dBm/MHz | 11 dBm/MHz | 30 dBm/500 |
| | STA: | | | kHz |
| | 11 dBm/MHz | | | |
| Antenna | 6 dBi | 6 dBi | 6 dBi | 6 dBi |
| gain | | | | |
| Unwanted | −27 | 27 dBm/MHz | 27 dBm/MHz | 27 |
| emission | dBm/MHz | | | dBm/MHz |

Note
B: 26 dB emission bandwidth in MHz

In a case of a 5 GHz band, the maximum transmission output and PSD limitations are defined according the frequency band as shown in Table 17 above. Accordingly, the terminal may determine the maximum transmission output and PSD limitations defined in the frequency band in which the terminal and the base station perform communication with each other, and the terminal may transmit an uplink signal/channel by determining transmission power of the uplink signal/channel so as to satisfy the determined limitations. However, in a case of a 6 GHz unlicensed band, the maximum transmission output and PSD limitations are defined according to the usage of the unlicensed frequency as shown in Table 18 below, and thus, the terminal may not correctly determine the maximum transmission output and PSD limitations by using only information on the frequency band in which the base station and the terminal perform communication with each other.

Table 18 shows an example of the maximum transmission output and PSD requirements in the 6 GHz unlicensed band in South Korea, United States, and Europe.

TABLE 18

| | | South Korea | United States | Europe |
|---|---|---|---|---|
| Indoor use | Allowed | 5925-7125 MHz | 5925-7125 MHz | 5945-6425 MHz |
| | band | | | |
| | Allowed | 2 dBm/MHz | AP: 30 dBm & | 23 dBm EIRP & |
| | output | | 5 dBm/MHz | 10 dBm/MHz |
| | | | STA: 24 dBm & | |
| | | | −1 dBm/MHz | |
| | Unwanted | −27 dBm/MHz | −27 dBm/MHz | [−15 dBm/MHz] |
| | emission | | | or [−36 |
| | | | | dBm/MHz] |
| | | | | (under |
| | | | | discussion) |
| Very low | Allowed | 5925-6425 MHz | 5925-7125 MHz | 5945-6425 MHz |
| power | band | | (under | |
| (VLP) use | | | discussion) | |
| | Allowed | 1 dBm/MHz < | 14 dBm | 14 dBm EIRP & |
| | output | 20 MHz | (under | [10 dBm/MHz] |
| | | −2 dBm/MHz < | discussion) | or [1 dBm/MHz] |
| | | 40 MHz | | (under |
| | | −5 dBm/MHz < | | discussion) |
| | | 80 MHz | | |
| | | −8 dBm/MHz < | | |
| | | 160 MHz | | |
| | Unwanted | −34 dBm/MHz | At the same | [−30 dBm/MHz] |
| | emission | | level as that of | or [−49 |
| | | | indoor use | dBm/MHz] |
| | | | | (under |
| | | | | discussion) |
| Fixed | Allowed | To be reviewed | 5925-6425, | N/A |
| outdoor | band | | 6525-6875 MHz | |
| use | Allowed | | AP: 36 dBm & | |
| | output | | 23 dBm/MHz | |
| | | | STA: 30 dBm & | |
| | | | 17 dBm/MHz | |
| | Unwanted | | −27 dBm/MHz | |
| | emission | | | |

A case in the United States is described as an example as follows. In a case where a terminal, which is to perform communication with the base station in the 5925 MHz unlicensed band, attempts initial access to the base station, the terminal having acquired synchronization and system information by detecting a synchronization signal block transmits a random access channel to the base station. In this case, the transmission power of the random access channel may be determined according to Equation 2 below.

P_{PRACH,b,f,c}(i)=min{P_{CMAX,f,c}(i),P_{PRACH,target,f,c}+PL_{b,f,c}}[dBm] Equation 2: PRACH transmission power

Here, P_{CMAX,f,c}(i) indicates the maximum output power configured at transmission time point i of carrier f in cell c. In this case, P_{CMAX,f,c}(i) indicates the output power which can be configured by the terminal, and may be configured with a value smaller than or equal to a smaller value between a power class of the terminal and the maximum output power value (for example, P-Max of FrequencyInfoUL IE) configured for the terminal by the base station through a higher-layer signal. P_{PRACH,target,f,c} is PRACH target reception power configured through higher-layer signaling (for example, PREABLE_RECEIVED_TARGET_POWER) for uplink active bandwidth part b of carrier f in serving cell c. PL_{b,f,c} is a pathloss value for uplink active bandwidth part b of carrier f in serving cell c, and is determined by using downlink reference signal associated with the PRACH transmission and reference signal power information, higher-layer filter configuration information, and the like. In this case, the terminal may be provided with the reference power information (for example, referenceSignalPower) from the base station through higher-layer signaling. If the activated downlink bandwidth part is the initial DL bandwidth part (BWP), and the terminal to which multiplexing of the synchronization signal block and a resource set through multiplexing pattern 2 or 3 is indicated determines PL_{b,f,c} by using the synchronization signal block associated with the PRACH transmission. The details of the higher-layer filtered RSRP and the multiplexing pattern of the synchronization signal block and the resource set are to be referred to 3GPP specifications (TS38.215, TS38.331, TS38.213, etc.).

Accordingly, in a case where the terminal, which is to perform communication with the base station in the 5925 MHz unlicensed band, transmits a random access channel for initial access to the base station, when the usage of the unlicensed bandwidth by the base station/terminal corresponds to the indoor use, the terminal is to determine transmission power so that the maximum output power is to be 24 dBm or lower and the PSD of the random access channel is to be −1 dBm/M4 Hz or lower, and is to transmit the random access channel according to the determined transmission power. When the usage of the unlicensed bandwidth by the base station/terminal corresponds to the outdoor use or the fixed outdoor use, the terminal is to determine transmission power so that the maximum output power is to be 30 dBm or lower and the PSD of the random access channel is to be 17 dBm/MHz or lower, and is to transmit the random access channel according to the determined transmission power. In this case, the terminal cannot identify the usage of the 6 GHz unlicensed band of the base station, and thus, the terminal may not correctly determine the maximum output power and PSD limitations defined in the unlicensed band, or may determine transmission power by assuming the lowest maximum output power and PSD limitations, whereby the quality of communication may deteriorate. Therefore, the disclosure proposes a method for explicitly or implicitly determining the usage of an unlicensed band of the base station by the terminal and a method for determining uplink transmission power according to the determined usage. In the above description, an example of determining PRACH transmission power by the terminal is described, but an embodiment of the disclosure may be performed to determine, by the terminal, transmission power of a physical uplink channel (PUCCH), a physical uplink shared channel (PUSCH), a sounding reference signal (SRS), a sidelink-synchronization signal/physical sidelink broadcast channel (SS/PSBCH), a physical sidelink shared channel (PSSCH), a physical sidelink control channel (PSCCH), a physical sidelink feedback channel (PSFCH), and the like, and transmission power of a reference signal.

Unlike the case in the 5 GHz unlicensed band, the maximum transmission output and PSD requirements in the 6 GHz unlicensed band is determined depending on the usage of a device, for example, depending on whether the device is for indoor use, VLP use, or output use. Accordingly, a base station or an AP (hereinafter, referred to as a base station) is to determine transmission power of a downlink signal and/or channel, which satisfies the maximum transmission output and the PSD requirements according to the usage, so as to transmit the same to a terminal or an STA (hereinafter, referred to as a terminal), wherein the transmission power may be configured for each base station when the base station is installed. However, the terminal which accesses the base station and is to transmit an uplink signal/channel, cannot identify the usage of the accessing base station or the base station to access, and cannot thus correctly determine the uplink transmission power. In other words, when the terminal is to determine transmission power for an uplink signal and/or channel (hereinafter, referred to as an uplink signal/channel) to transmit the uplink signal/channel, the terminal cannot identify the maximum transmission output and PSD requirements to be satisfied for uplink transmission, and cannot correctly thus determine the uplink transmission power. In order to solve the problem above, at least one of the following methods is required.

Method 1: According to this method, the base station notifies the terminal of the usage of the base station (or frequency) or information corresponding thereto through higher-layer signaling, and the terminal determines transmission power for an uplink signal/channel according to the determined maximum power and/or PSD requirements by using the information.

Method 1 is a method in which the base station provides the terminal with the usage of the base station (or frequency) or information corresponding thereto through higher-layer signaling, and the terminal having received the same determines the maximum power and/or PSD requirements according to the information, and accordingly, determines transmission power of an uplink signal and/or channel. For example, the base station provides the terminal with at least one piece of information of, as information on the usage of the unlicensed band, the indoor use, the VLP use, and the outdoor use, through higher-layer signaling as shown in Table 19 below. Here, providing the terminal with the information through UsageOf6 GHz of higher-layer signaling ServingCellConfigCommonSIB is a mere example, and the disclosure is not limited thereto.

TABLE 19
ServingCellConfigCommonSIB::= SEQUENCE {
downlinkConfigCommon DownlinkConfigCommonSIB,
...
UsageOf6GHz ENUMERATED {indoor, VLP, outdoor},
...
},

The terminal having been provided with the usage information of the unlicensed band from the base station determines the maximum transmission power and/or PSD requirements which can be used when the terminal transmits an uplink signal/channel, by using one or more pieces of information of the location or local information of the accessing base station or a cell or a base station to access, information on a frequency band to be used for communication, information on the usage of the unlicensed band of the base station, the maximum power and/or PSD requirements such as Table 18, and the like. For example, when the base station to access is located in the United States, the frequency band to be used for communication is a 6 GHz unlicensed band, and information on the usage of the unlicensed band of the base station, the information being provided from the base station through higher-layer signaling, corresponds to outdoor use, the terminal may determine with reference to Table 18 that the maximum transmittable power is 30 dBm or lower and that the PSD of the uplink signal/channel is to be 17 dBm/MHz or lower, and accordingly, may determine the transmission power of the uplink signal/channel.

Here, the terminal may determine the frequency band information through the detected or acquired frequency location of a synchronization signal block of the base station or the cell, through the frequency band information provided from the base station through a higher-layer signal, through the location of a sync raster in which the synchronization signal block can be located, and/or the detected or acquired location of the synchronization signal block. Here, the terminal may determine the location or the local information of the cell or the base station by using at least one piece of information of a public land mobile network (PLMN) (public identity (PLMN-identity)), a tracking area code (TrackingAreaCode), and a RAN area code (RAN-AreaCode), which are provided from the base station through a higher-layer signal (for example, CellAccessRelatedInfo). For example, the terminal may determine the location or the local information of the base station through the pre-defined or pre-programed location information for each PLMN ID.

Method 2: According to this method, the base station notifies the terminal of at least one of the maximum power and/or PSD requirements for uplink transmission of the terminal through higher-layer signaling, and the terminal determines transmission power for an uplink signal/channel according to the determined maximum power and/or PSD requirements by using the information.

Method 2 is a method in which the base station provides the terminal with all or part of regulation information defined for the unlicensed band used when for communication with the terminal, for example, at least one piece of information of the maximum transmittable power and PSD requirements, through a higher-layer signal, and the terminal having received the same determines transmission power of an uplink signal/channel according to the information. For example, the base station provides the terminal with at least one piece of the maximum transmittable power and PSD information through higher-layer signal information as shown in Table 20 below. Here, providing the terminal with the information through p-Max or PSD-Max of higher-layer signaling FrequencyInfoUL-SIB is a mere example, and the disclosure is not limited thereto.

```
TABLE 20
FrequencyInfoUL-SIB::= SEQUENCE {
frequencyBandList MultiFrequencyBandListNR-SIB
...
p-Max P-Max
  p-MaxFor6GHz P-Max2 or INTEGER (1..36) (dBm)
  PSD-Max P-Max3 or INTEGER (-8..23) (dBm)
}
```

In this case, the terminal may transmit the maximum transmittable power for the 6 GHz unlicensed band to the terminal through a separate IE (for example, “p-MaxFor6 GHz” in Table 20 above), or may transmit the same to the terminal by using a p-Max value without a separate IE. If the terminal has not provided with the separate maximum transmittable power value for the 6 GHz unlicensed band such as p-MaxFor6 GHz from the base station, the terminal may determine that the p-Max value corresponds to the maximum transmittable power of the unlicensed band, and determine transmission power of the uplink signal/channel according to the information and PSD information (for example, PSD-Max).

For example, the base station provides the terminal with at least one piece of regulation information such as the maximum transmission power and/or PSD as defined in Table 18 above for the unlicensed band to be used for communication with the terminal, through a higher-layer signal. An example of the information may include at least one of the maximum transmission power or PSD which can be used when the terminal transmits the uplink signal/channel. For example, when the base station to access is located in the United States, the frequency band to be used for communication is a 6 GHz unlicensed band, and the base station is to use the unlicensed band for outdoor use, the base station may configure the maximum transmittable power of the uplink signal/channel as 30 dBm or lower (hereinafter, a value for p-Max or p-MaxFor6 GHz is 30 dBm) and the PSD of the uplink signal/channel as 17 dBm/MHz (for example, a value of PSD-Max is 17 dBm) and provide the terminal with the same. The terminal having received the information may determine transmission power of the uplink signal/channel by using the maximum transmittable power and PSD information provided or configured by the base station.

Method 3: According to this method, the terminal determines at least one of the maximum power and/or PSD requirements for uplink transmission through information related to downlink and/or uplink transmission power provided through higher-layer signaling, and accordingly determines transmission power for an uplink signal/channel.

Method 3 is described more specifically as follows. The base station provides or configures the terminal with at least one value of regulation information such as the maximum transmission power and/or PSD as defined in Table 18 above for the unlicensed band to be used for communication with the terminal by using at least one value of higher-layer signal information (for example, ss-PBCH-BlockPower) providing information on transmission power of a synchronization signal block and higher-layer signal information (for example, p_Max) providing a maximum uplink transmittable power value. The example may be as shown in Table 21 below. When the unlicensed band used for communication with the base station corresponds to the frequency band in Table 18, the terminal having received the information may determine the usage of the unlicensed band of the base station by using at least one value of higher-layer signal information (for example, ss-PBCH-BlockPower as shown in Table 21 below) providing information on provided or configured transmission power of a synchronization block and higher-layer signal information (for example, p-Max) providing a maximum uplink transmittable power value, and may determine transmission power of an uplink signal/channel according to the maximum transmission power and PSD defined according to the determined usage.

TABLE 21
ServingCellConfigCommonSIB::= SEQUENCE {
downlinkConfigCommon DownlinkConfigCommonSIB
...
ss-PBCH-BlockPower INTEGER (-60..50),
...
}

For example, when the terminal has been provided or configured from the base station with that a value of higher-layer signal information providing transmission power of a synchronization block is 30 dBm and a value of higher-layer signal information providing the maximum uplink transmittable power value is 24 dBm, the terminal may determine or assume that the base station uses the unlicensed band for indoor use and determines the PSD requirements corresponding thereto. In this case, the terminal may determine that the PSD requirements correspond to −1 dBm/MHz, and may accordingly determine transmission power of the uplink signal/channel.

In another example, when the terminal has been provided or configured from the base station with that a value of higher-layer signal information providing transmission power of a synchronization block is 36 dBm and a value of higher-layer signal information providing the maximum uplink transmittable power value is 30 dBm, the terminal may determine or assume that the base station uses the unlicensed band for outdoor use and determine the PSD requirements corresponding thereto. In this case, the terminal may determine that the PSD requirements correspond to 17 dBm/MHz, and may accordingly determine transmission power of the uplink signal/channel. The terminal may also directly determine the PSD requirements through the higher-layer signal information without determining the usage of the unlicensed band of the base station.

Method 4: According to this method, the terminal determines the maximum transmittable power and/or PSD requirements according to a connection type between the terminals, and accordingly determines transmission power for a signal and/or channel.

Method 4 is a method in which when the terminal performs terminal-to-terminal communication (or device-to-device communication) through sidelink in the unlicensed rand, the terminal determines that the unlicensed band is used for specific use, for example, VLP use, and determines transmission power of a sidelink signal/channel according to the maximum transmission power and PSD requirements corresponding to the VLP use in Table 18. When the terminal performs sidelink communication which means terminal-to-terminal communication, the terminal may perform the sidelink communication by using relatively lower power than that required in a case where the terminal performs communication with the base station. Accordingly, in a case where the terminal performs sidelink communication according to a sidelink communication configuration provided or configured from the base station through a higher-layer signal or pre-defined (pre-configured) for the terminal, when the sidelink communication is performed through a 6 GHz unlicensed band, the terminal may determine that the unlicensed band is for VLP use. Thereafter, the terminal may determine transmission power of the sidelink signal/channel to satisfy the maximum transmission power and PSD requirements corresponding to the VLP use in Table 18.

With regard to various methods of the disclosure, the terminal may determine the frequency location or the frequency band information through one or more of the following methods. The terminal may detect and acquire a synchronization signal block of the cell or the base station, and determine frequency band information (for example, allowed band information in Table 18) through the acquired frequency location of the synchronization signal block. According to another method, the terminal may determine the frequency location or the frequency band information through frequency band information provided from the base station through a higher-layer signal, or determine the same through the location of a sync raster in which the synchronization signal block can be located and/or the detected or acquired location of the synchronization signal block, etc.

In addition, with regard to various embodiments of the disclosure, the location or the local information of the cell or the base station may be determined by using at least one piece of information of a PLMN (public identity (PLMN-identity), a tracking area code (TrackingAreaCode), and a RAN area code (RAN-AreaCode), which are provided from the base station through a higher-layer signal (for example, CellAccessRelatedInfo). Table 22 shows an example of the PLMN-Identity. For example, the terminal may determine the location or the local information of the base station through the pre-defined or pre-programed location information for each PLMN ID. Here, MCC refers to a mobile country code (MCC), and the terminal may determine a country in which the accessing base station or network is located, and determine the maximum transmission power and PSD requirements according to the determined country and Table 18.

TABLE 22

PLMN-Identity ::= SEQUENCE {
mcc MCC OPTIONAL, -- Cond MCC
mnc MNC
}

In another example, the terminal may determine the location or the local information of the cell or the base station through international mobile subscriber identity (IMSI) information provided from the base station or the network. For example, the first three bits of the IMSI, which is normally represented by a 15-digit number, correspond to a mobile country code (MCC), and thus the terminal may determine the country of the accessing network through the bits, and determine the maximum transmission power and PSD requirements according to the determined country and Table 18.

In addition, the maximum transmittable power determined through various methods of the disclosure may be represented by at least one of p-Max, a P_{CMAX,f,c}(i) value, or a maximum value of P_{CMAX,f,c}(i). In this case, the terminal needs to satisfy the PSD conditions determined through various methods of the disclosure. For example, when it is indicated or determined to or for the terminal, which performs communication by using a 6 GHz unlicensed band in the United States, that the unlicensed band is for indoor use, the terminal needs to determine transmission power of an uplink signal/channel so that the maximum PSD or the maximum mean power density in any 1 MHz band is −1 dBm or lower and the maximum transmission power is 24 dBm or lower. When it is indicated or determined that the unlicensed band is for outdoor use, the terminal needs to determine transmission power of an uplink signal/channel so that the maximin PSD or the maximum mean power density in any 1 MHz band is 17 dBm or lower and the maximum transmission power is 30 dBm.

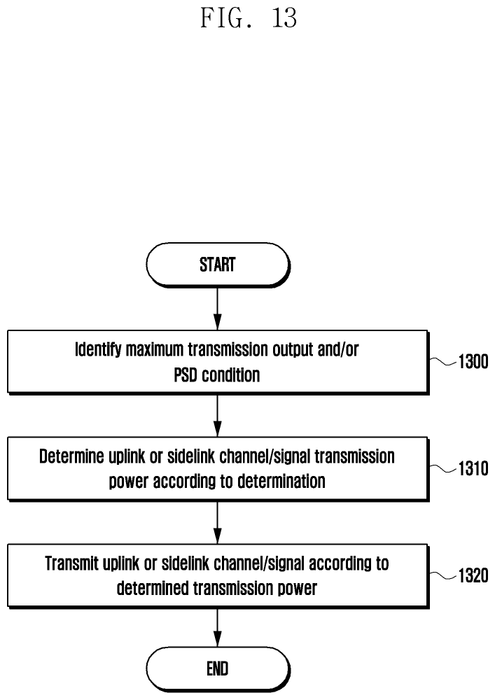

FIG. 13 illustrates an operation of a terminal which performs an embodiment of the disclosure.

Referring to FIG. 13, a terminal identifies maximum transmission power (or interchangeably used with “maximum transmittable power”) and/or PSD information to be applied to uplink or sidelink signal/channel transmission in an unlicensed band at operation 1300. The terminal may acquire the maximum transmission power and/or PSD information to be applied, by using at least one of information on a frequency band used for signal transmission, the location or location information of a cell or a base station to access, or information on the usage of the frequency band or the base station, wherein the frequency band information and the location or the local information of the cell or the base station may be acquired according to methods described above.

For example, when the frequency band to be used for signal transmission is 6 GHz, the maximum transmission output and/or PSD information may vary depending on the usage of the frequency band or the base station, and the terminal may acquire the maximum transmission output and/or PSD information according to the method described above. According to method 1, the terminal may determine the usage of the frequency band or the base station through the information indicating the usage of the base station or the frequency, the information being transmitted from the base station, and acquire the corresponding maximum transmission output and/or PSD information. According to method 2, the terminal may acquire the maximum transmission output and/or PSD information through at least one piece of information of the maximum transmittable power and/or PSD requirements transmitted from the base station. According to method 3, the terminal may acquire the maximum transmission output and/or PSD information according to downlink or uplink transmission power-related information transmitted from the base station. According to method 4, when terminal-to-terminal communication is performed through a sidelink, the terminal may determine the usage of the frequency band as specific use, and acquire the maximum transmission output and/or PSD information.

The terminal determines uplink or sidelink signal/channel transmission power by using the acquired maximum transmission output and/or PSD information (operation 1310). The terminal may use the acquired maximum transmission output information to identify a P_{CMAX,f,c}(i) parameter used in determining the transmission power. For example, the terminal may determine at least one of p-Max, a P_{CMAX,f,c}(i) value, or a maximum value of P_{CMAX,f,c}(i). In addition, the terminal determines transmission power to satisfy the PSD or the maximum average power density. Thereafter, the terminal transmits an uplink or sidelink signal/channel by using the determined transmission power of the uplink or sidelink signal/channel (operation 1320).

It is not necessarily required that all operations in FIG. 13 should be performed to carry out the disclosure, and additional operations that are not described may be added. In addition, the described sequence may change.

The above-described embodiments of the disclosure are not alternatives to each other, and one or more methods may be used in combination. Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the disclosure, the term “computer program product” or “computer readable recording medium” is used to entirely refer to a medium such as a memory, a hard disk installed in a hard disk drive, and a signal. The “computer program product” or “computer-readable recording medium” may be used in a method for monitoring a downlink control channel in a wireless communication system according to the disclosure.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents. Further, the above respective embodiments may be employed in combination, as necessary. For example, one embodiment of the disclosure may be partially combined with any other embodiment to operate a base station and a terminal. Further, the embodiments of the disclosure may be applied to other communication systems and other variants based on the technical idea of the embodiments may be implemented. For example, the embodiments may be applied to LTE systems, 5G systems, NR systems, etc.

What is claimed is:

1. A method performed by a terminal in a communication system, the method comprising:
receiving, from a base station, information on at least one of maximum transmit power or power spectral density (PSD) for an unlicensed band via higher layer signaling;
identifying a transmit power of an uplink signal or a sidelink signal based on the information on at least one of the maximum transmit power or the PSD; and
transmitting the uplink signal or the sidelink signal based on the identified transmit power on the unlicensed band,
wherein the unlicensed band corresponds to a 6 gigahertz (GHz) band.

2. The method of claim 1, further comprising:
identifying a use of the unlicensed band based on the information on at least one of the maximum transmit power or the PSD,
wherein the transmit power is identified based on the use of the unlicensed band.

3. The method of claim 1, wherein the higher layer signaling corresponds to a system information block (SIB).

4. The method of claim 1, wherein the information on at least one of the maximum transmit power or the PSD corresponds to p-Max information.

5. The method of claim 4, wherein the p-Max information comprises at least one of maximum power information for the 6 GHz band or PSD information for the 6 GHz band.

6. A method performed by a base station in a communication system, the method comprising:
transmitting, to a terminal, information on at least one of maximum transmit power or power spectral density (PSD) for an unlicensed band via higher layer signaling; and
receiving, from the terminal, an uplink signal associated with a transmit power on the unlicensed band,
wherein the transmit power of the uplink signal corresponds to the information on at least one of the maximum transmit power or the PSD, and
wherein the unlicensed band corresponds to a 6 gigahertz (GHz) band.

7. The method of claim 6, wherein a use of the unlicensed band is associated with the information on at least one of the maximum transmit power or the PSD.

8. The method of claim 6, wherein the higher layer signaling corresponds to a system information block (SIB).

9. The method of claim 6, wherein the information on at least one of the maximum transmit power or the PSD corresponds to p-Max information.

10. The method of claim 9, wherein the p-Max information comprises at least one of maximum power information for the 6 GHz band or PSD information for the 6 GHz band.

11. A terminal in a communication system, the terminal comprising:
a transceiver; and
a controller coupled with the transceiver and configured to:
receive, from a base station, information on at least one of maximum transmit power or power spectral density (PSD) for an unlicensed band via higher layer signaling,
identify a transmit power of an uplink signal or a sidelink signal based on the information on at least one of the maximum transmit power or the PSD, and
transmit the uplink signal or the sidelink signal based on the identified transmit power on the unlicensed band,
wherein the unlicensed band corresponds to a 6 gigahertz (GHz) band.

12. The terminal of claim 11,
wherein the controller is further configured to identify a use of the unlicensed band based on the information on at least one of the maximum transmit power or the PSD, and
wherein the transmit power is identified based on the use of the unlicensed band.

13. The terminal of claim 11, wherein the higher layer signaling corresponds to a system information block (SIB).

14. The terminal of claim 11, wherein the information on at least one of the maximum transmit power or the PSD corresponds to p-Max information.

15. The terminal of claim 14, wherein the p-Max information comprises at least one of maximum power information for the 6 GHz band or PSD information for the 6 GHz band.

16. A base station in a communication system, the base station comprising:
a transceiver; and
a controller coupled with the transceiver and configured to:
transmit, to a terminal, information on at least one of maximum transmit power or power spectral density (PSD) for an unlicensed band via higher layer signaling, and
receive, from the terminal, an uplink signal associated with a transmit power on the unlicensed band,
wherein the transmit power of the uplink signal corresponds to the information on at least one of the maximum transmit power or the PSD, and
wherein the unlicensed band corresponds to a 6 gigahertz (GHz) band.

17. The base station of claim 16, wherein a use of the unlicensed band is associated with the information on at least one of the maximum transmit power or the PSD.

18. The base station of claim 16, wherein the higher layer signaling corresponds to a system information block (SIB).

19. The base station of claim 16, wherein the information on at least one of the maximum transmit power or the PSD corresponds to p-Max information.

20. The base station of claim 19, wherein the p-Max information comprises at least one of maximum power information for the 6 GHz band or PSD information for the 6 GHz band.
